(19) United States
(12) Patent Application Publication
(10) Pub. No.: US 2024/0332568 A1
(43) Pub. Date: Oct. 3, 2024

(54) LIQUID SEPARATOR

(71) Applicant: EKPO Fuel Cell Technologies GmbH, Dettingen (DE)

(72) Inventors: Eugen KUEBLER, Dettingen (DE); Armin EHNI, Dettingen (DE); Torsten STIFEL, Dettingen (DE); Benjamin DIEHL, Dettingen (DE); Frederik WEINMANN, Dettingen (DE); Marco SAILE, Dettingen (DE); Stefan HEMMER, Dettingen (DE); Juergen KRAFT, Dettingen (DE); Wadim KAISER, Dettingen (DE)

(73) Assignee: EKPO Fuel Cell Technologies GmbH, Dettingen (DE)

(21) Appl. No.: 18/737,868

(22) Filed: Jun. 7, 2024

Related U.S. Application Data
(63) Continuation of application No. PCT/EP2022/085264, filed on Dec. 9, 2022.

(30) Foreign Application Priority Data
Dec. 13, 2021 (DE) 10 2021 214 236.2

(51) Int. Cl. H01M 8/04119; F16T 1/34

(52) U.S. Cl. CPC H01M 8/04164; F16T 1/34; H01M 2250/20

(57) ABSTRACT

The invention relates to a liquid separator (100), in particular for a fuel cell device, the liquid separator (100) comprising the following: a fluid-conducting channel (104), a collection region (106) for collecting liquid originating from a fluid that is conducted in the fluid-conducting channel (104), a liquid passage (110) branching off from the fluid-conducting channel (104) and a liquid collection region (112) into which the liquid passage (110) leads.

### RELATED APPLICATION

This application is a continuation of international application No. PCT/EP2022/085264 filed on Dec. 9, 2022, and claims the benefit of German application No. 10 2021 214 236.2 filed on Dec. 13, 2021, which are incorporated herein by reference in their entirety and for all purposes.

### FIELD OF DISCLOSURE

The present invention concerns the field of liquid separators, in particular liquid separators which are necessary for the assembly and supply of a fuel cell stack of a fuel cell device.

For example, an end plate for a fuel cell stack is known from DE 10 2004 049 623 B4.

### BACKGROUND

DE 10 2017 212 091 A1 describes a fluid-guiding unit for supplying fuel and/or oxidator and/or coolant to the fuel cell elements and/or for discharging fuel and/or oxidator and/or exhaust gas and/or coolant from the fuel cell elements. The fluid-guiding unit comprises a base body. This comprises multiple fluid lines and connection points for connection of supply lines and/or discharge lines and/or additional components of the fuel cell device.

In many fuel cell stacks, water is formed from hydrogen (H₂) and oxygen (O₂). In fuel cells which work with other fuels, e.g. methanol, water also often occurs as a product of the electrochemical reaction.

In addition, usually various amounts of water are introduced into the fuel cell with the supplied air.

It is known that the water present in the fuel cell can lead to problems in starting of a vehicle, in particular very low temperatures. Even during operation, accumulations of liquid in the pipe system of fuel cells can lead to problems. Depending on the operating state of a vehicle powered by a fuel cell, fluctuations in the water content of the fluids supplied to the fuel cell stack (e.g. hydrogen and air) can occur. This can hinder continuous operation of the fuel cell under optimal conditions.

### SUMMARY OF THE INVENTION

The object of the present invention is to provide a device for a fuel cell which allows reliable operation of the fuel cell even under extreme conditions such as low temperatures and non-constant travel.

This object is achieved according to the invention with the features of claim 1.

Preferably, the liquid separator is a liquid separator for a fuel cell device, in particular a liquid separator for a fuel cell device of a vehicle. However, the invention is not restricted to this. The liquid separator is also suitable for separating liquid from other fluids. It can be used particularly advantageously wherever the liquid content of the fluid stream fluctuates and/or the separated liquid must initially remain in a liquid-collecting region which lies close to the fluid-conducting channel from which the liquid was separated.

The fluid-conducting channel may be any form of channel in which a fluid can be conveyed. Typically, the fluid-conducting channel extends from a fluid inlet to a fluid outlet. It is however also conceivable that multiple fluid inlets and/or fluid outlets are provided, i.e. the fluid in the fluid-conducting channel is conveyed into branches.

The liquid separator comprises a catchment region for capturing liquid from a fluid which can be conveyed in the fluid-conducting channel. The fluid is typically a gas which contains the liquid droplets.

The catchment region is typically a region of an inner surface of a fluid-conducting channel wall. In this region, liquid is captured from the fluid, preferably liquid droplets from the gas. The catchment region may for example lie against a radially outer channel wall of the fluid-conducting channel in the flow direction of the fluid. The density of the drops is greater than that of the surrounding gas so that the drops are driven outward from the flowing fluid and meet the catchment region. A catchment region may however also lie in a region of the fluid-conducting channel with slower through-flow. There, the shear forces may be so low that, once in contact with the surface of the channel wall, the liquid remains there and is not detached again directly by the flowing fluid. A surface of a liquid-conducting element, described in more detail below, may also form a catchment region.

The liquid separator preferably comprises a liquid passage branching from the fluid-conducting channel. This is typically an opening in the channel wall through which the liquid can emerge from the fluid-conducting channel.

The liquid separator also preferably comprises a liquid-collecting region into which the liquid passage opens. The liquid-collecting region is connected to the fluid-conducting channel via the liquid passage, preferably such that liquid escaping from the fluid-conducting channel through the liquid passage can drip and/or flow into the liquid-collecting region.

The liquid separator allows reliable operation of the fuel cell at low temperatures. The targeted discharge of liquid, typically water, into the liquid-collecting region ensures that other undesirable water accumulations in the pipe system can be reduced to a minimum or prevented completely. The liquid-collecting region may again be configured such that a volume of any residual water is a small as possible. If it freezes, it melts very quickly on subsequent operation of the fuel cell.

The liquid separator preferably allows reliable operation of the fuel cell even on non-constant travel, e.g. on acceleration, braking or cornering. Once escaped through the liquid passage, the liquid—even when sloshing roughly around in the liquid region e.g. because of strong acceleration, braking or cornering—cannot return to the fluid-conducting channel in significant quantities. An ingress of splash water via the anode or cathode gas can preferably be largely avoided by the invention.

A transition from the catchment region to the liquid passage may form an outflow zone via which a liquid, which can be captured in the catchment region, can flow out to the liquid passage. It is conceivable that little or no liquid is captured on the inner surface of the channel wall in the immediate vicinity of the liquid passage. However, liquid collecting there can preferably flow to the liquid passage, so that an outflow zone is present there.

Preferably, a liquid-conducting element leads to the liquid passage. A preferred liquid-conducting element extends from an inner surface of the channel wall into the fluid-conducting channel and runs along the inner surface of the channel wall.

It may be favorable if, over the entire length of the liquid-conducting element, the liquid-conducting element extends into the fluid channel by an average of 3% to 40%, for example by 5% to 30% of the local radius of the inner surface of the channel wall. The local radius is the mean radius in the region of the channel in which the liquid-conducting element is situated. This preferably guarantees that captured liquid can flow along the liquid-conducting element to the liquid passage without being carried away to a greater extent via the liquid-conducting element and thus re-entering the flowing fluid. This preferably also guarantees that the flow resistance in the liquid-conducting channel remains low.

It may furthermore be preferable if the liquid-conducting element runs preferably helically along the inner surface of the channel wall. Helical means that the liquid-conducting element runs parallel to at least a part of a winding of a theoretical helix which extends spirally around on the surface of the fluid-conducting channel from the fluid inlet to the fluid outlet. The helical course means that liquid flows in a defined direction along the liquid-conducting element.

Preferably, one or more liquid-conducting elements, in particular all liquid-conducting elements, are oriented obliquely to a local extent or orientation of the fluid-conducting channel. In particular, for example, ribbed or stepped liquid-conducting elements enclose an angle of at least around 5°, preferably at least around 15°, and/or at most around 60°, preferably at most around 45°, with the respective local extent or orientation of the fluid-conducting channel.

The local extent or orientation is in particular a tangent lying against a middle path of the fluid-conducting channel, wherein the middle path runs through all middle points of the fluid-conducting channel arranged centrally in the radial direction.

In a helical course of one or more liquid-conducting elements, a pitch angle of the theoretical helix relative to a helix center axis is preferably at least 5°, for example at least 15°, and/or at most around 60°, preferably at most around 45°.

Preferably, a catchment region and liquid passage spaced therefrom may be formed on the same side of a helical liquid-conducting element. Preferably, an outflow zone then runs along the liquid-conducting element from the catchment region to the liquid passage. This may offer the advantage that a relatively large amount of liquid can be separated in targeted fashion from a large catchment region through a relatively small liquid passage. The risk of liquid splashing back from the collection region into the fluid-conducting channel can preferably be further reduced thereby. During non-constant travel, in particular an even more reliable operation of the fuel cell is thus ensured.

The liquid passage may have any form.

A preferred liquid passage has an elongate cross-section. The greatest length of the cross-section is preferably at least twice, preferably at least three times as large as the greatest width of the cross-section orthogonally thereto.

It may be advantageous if one or more liquid-conducting elements each cooperate with one or more liquid passages.

It may be favorable if one or more liquid passages each adjoin one or more liquid-conducting elements.

For example, it may be provided that one or more liquid passages adjoin a separating side of one or more liquid-conducting elements, in particular such that liquid separated at the one or more liquid-conducting elements can be conveyed directly to the one or more liquid passages.

It may be advantageous if one or more liquid passages each extend along one or more liquid-conducting elements.

In particular, it may be provided that one or more liquid passages are formed as slots.

For example, it may be provided that several rib-like liquid-conducting elements and several slot-like liquid passages are provided, which for example are arranged and/or formed cooperating in pairs. In particular, a slot-like liquid passage may adjoin each rib-like liquid-conducting element.

The liquid passage in the channel wall is preferably oriented parallel to a liquid-conducting element. This may have the advantage that the orientation of the liquid passages can be precisely tailored to the liquid flowing along the liquid-conducting element to the liquid passage in a narrow strip.

It may be preferred if at least one liquid passage is provided for each liquid-conducting element. This shortens the mean length of the outflow zones.

Preferred liquid separators according to the invention are centrifugal separators; for example, the fluid-conducting channel may have one or more curvatures or be guided in a helical, cyclonic or swirling pattern.

According to the invention, a liquid-conducting material may be arranged in a catchment region and/or an outflow zone. Suitable liquid-conducting materials are a fleece, a sufficiently liquid-permeable porous material (e.g. a foam), a woven fabric, a net, or a perforated or slotted flat material, which may for example have longitudinal or transverse channels and/or forms a double floor to the channel wall.

These liquid-conducting materials preferably ensure that once droplets have been captured in the catchment region, they cannot be torn away again by the flowing fluid and thereby returned to the fluid stream. Drops already captured can accordingly preferably flow more securely into the liquid-collecting region.

Preferably, the fluid-conducting channel has at least one curvature, for example at least two curvatures. Further preferably, at least a part of the catchment region is formed on a channel wall of the fluid-conducting channel lying radially on the outside in the flow direction of the fluid.

In the curvature, the fluid preferably flows through a flow curve. The catchment region lies in particular on the outside of this flow curve, for example in an outer curve region.

The channel wall lying radially on the outside in the flow direction of the fluid is thus in particular the channel wall which outwardly delimits the flow curve, in particular towards the curve outside.

Preferably, at least one liquid passage may also be formed on a channel wall of the fluid-conducting channel lying radially on the outside in the flow direction of fluid. This may have the advantage of a shorter outflow zone so that less captured liquid is carried away again by the fluid, thereby finally improving the liquid separation.

The curvature may be the curvature of a helical fluid-conducting channel. Apart from or in addition to the above-described possibility of a helical course of a liquid-conducting element, the fluid-conducting channel may itself be helical in form.

The fluid-conducting channel may for example be formed in a helix around a coolant channel.

Liquid separators according to the invention may have at least one, preferably at least two, particularly preferably at least three, for example at least four backflow barrier(s) arranged between the liquid-collecting region and the fluid-conducting channel.

The backflow barrier(s) is (are) preferably arranged such that any straight line intersecting any liquid passage of the fluid-conducting channel and intersecting a theoretical sphere on the base of the liquid-collecting region also intersects at least one backflow barrier.

This may have the advantage that a force acting on a liquid situated in the theoretical sphere at the base of the liquid-collecting region towards any liquid passage, cannot convey the liquid present there directly through this liquid passage. On braking, acceleration or cornering, an undesired backflow of collected liquid into the fluid-conducting channel then occurs more rarely. It may be particularly advantageous if this desired effect occurs for as large a volume as possible of collectible liquid.

The theoretical sphere may for example have the diameter of a largest sphere which still fits through any of the liquid passages. If multiple liquid passages are present, the liquid passage through which the largest sphere passes is decisive.

A theoretical sphere on the base of the liquid-collecting region means that the sphere lies at a lowest point of the liquid-collecting region. The theoretical sphere lies for example on the base of the liquid-collecting region as close as possible to a liquid outlet.

Liquid separators according to the invention may for example have mutually overlapping backflow barriers. Mutually overlapping backflow barriers are backflow barriers which are arranged relative to one another such that a straight line leading to a liquid passage firstly intersects one backflow barrier and then another backflow barrier. Mutually overlapping backflow barriers are preferably backflow barriers which are arranged relative to one another such that a first straight line leading through a liquid passage firstly intersects one backflow barrier, then a second, then optionally a third backflow barrier.

The backflow barrier(s) may have any form. They may for example comprise barrier panel elements, baffle panel elements or ribs.

Two barrier panel elements may for example together form a backflow barrier in the shape of a hipped roof.

Baffle panel elements may for example be formed starting from walls of the liquid-collecting region.

Preferably, the backflow barriers, e.g. barrier panel elements and/or baffle panel elements, are formed and/or configured and/or arranged such that they can be produced in an injection-molding process. At least part of their surfaces preferably runs in the direction of removal from a tool half used in the injection-molding process.

At least one backflow barrier may define a deflection region opening towards the liquid-collecting region.

The deflection region opening towards the liquid-collecting region means a region opening towards the liquid-collecting region. The term “deflection region” merely explains that a liquid present in the liquid-collecting region, which may be flung into this region by an active force, can then flow or drip back from this region into the liquid-collecting region.

The deflection region opening towards the liquid-collecting region preferably has two surfaces. The surfaces transform into one another in a region lying closer to the fluid-conducting channel. From this region lying closer to the fluid-conducting channel, they extend into regions lying further away from the fluid-conducting channel. This means that liquid flung into the deflection region can flow away via these two surfaces.

The deflection region opening towards the liquid-collecting region may be defined purely by the backflow barrier. It may however also be defined by a backflow barrier in conjunction with another surface of the liquid separator, for example in conjunction with an inner surface of a wall leading away into the liquid-collecting region.

The deflection region may be screened from the fluid-conducting channel for example by barrier panel elements sloping relative to one another, by a baffle panel element and/or by a barrier panel element oriented parallel to the adjacent portion of the fluid-conducting channel.

For barrier panel elements sloping relative to one another, the deflection region opening towards the liquid-collecting region typically comprises a surface of both barrier panel elements. These surfaces face one another and transform into one another in the region lying closer to the fluid-conducting channel. From this region lying closer to the fluid-conducting channel, they extend into regions lying further away from fluid-conducting channel. This means that liquid flung into the deflection region can flow away via these two mutually facing surfaces of the barrier panel elements.

For baffle panel elements, the deflection region opening towards the liquid-collecting region typically comprises a surface of a baffle panel element and a surface not formed by a baffle panel element. These surfaces face one another and transform into one another in a region lying closer to the fluid-conducting channel. From this region lying closer to the fluid-conducting channel, they extend into regions lying further away from fluid-conducting channel. This means that liquid flung into the deflection region can flow away via these two mutually facing surfaces.

Parallel to the adjacent portion of the fluid-conducting channel preferably means that an angle relative to the fluid-conducting channel portion amounts at most to 20°, in particular at most 10°.

At least two, particularly preferably at least three, for example at least four backflow barriers may for example each define a deflection region opening towards the liquid-collecting region. The deflection regions may be screened from the fluid-conducting channel for example by barrier panel elements sloping relative to one another and/or by baffle panel elements.

A liquid separator according to the invention may comprise ribs. The ribs may define a labyrinth path. The labyrinth path may run into the liquid-collecting region or inside the liquid-collecting region.

Ribs may for formed for example by barrier panel elements oriented parallel to the adjacent fluid-conducting channel portion, and/or by the floor of the liquid-collecting region. The ribs may for example run substantially vertically.

Generally, it is preferable to produce the liquid separator and/or the liquid-guiding unit comprising the liquid separator in multiple parts by injection-molding.

Depending on the component split, it may be advantageous to form the backflow barriers running vertically or horizontally.

If the component split runs horizontally and the liquid separator also comprises backflow barriers, these may for example be arranged on the floor of the liquid-collecting region. Alternatively or additionally, backflow barriers may be arranged on a component to be arranged above the liquid-collecting region and extending downward into the liquid-collecting region in the assembled state of the fluid-guiding unit. The component to be arranged above the liquid-collecting region may be a backflow barrier insert. The component to be arranged above the liquid-collecting region may however also be a component which comprises a lower part of the channel wall.

If a component split runs vertically and the liquid separator also comprises backflow barriers, these may for example be arranged on at least one of the two side components of the liquid separator or liquid-guiding unit which define the liquid-collecting region in the assembled state.

Preferably, a liquid outlet is formed in the liquid-collecting region. A preferred liquid outlet may assume an opened or closed state which for example may be achieved by a drainage valve.

The liquid outlet is preferably arranged in an outlet region branching downward from the liquid-collecting region. Its largest cross-section preferably does not exceed 2 cm², in particular 1 cm², for example 0.5 cm².

The outlet region may be a blind depression. The walls may be so steep and the diameter so small that it forms the lowest point of the liquid-collecting region. The depth of the blind depression may in particular be selected in the range from 2 mm to 20 mm, preferably 3 mm to 12 mm, for example 6 mm.

It is particularly preferred if a liquid outlet is formed in the liquid-collecting region, wherein the liquid outlet is formed in the liquid-collecting region such that it can be used for outlet of separated liquid in a first orientation of the liquid separator and in a second orientation of the liquid separator. The second orientation is tilted preferably by 90° relative to the first orientation.

This alone may ensure that the liquid separator can be used universally both in fuel cell stacks with horizontal cell orientation and in fuel cell stacks with vertical cell orientation.

With horizontal cell orientation, the stacked elements (membrane electrode arrangements, bipolar plates etc.) lie on top of one another. This means that gravity acts orthogonally to the central planes of the stacked elements.

With vertical cell orientation, the stacked elements (membrane electrode arrangements, bipolar plates etc.) are standing. This means that gravity acts along the central planes of the stacked elements.

The fuel cell stack with vertical cell orientation is thus tilted by 90° relative to the fuel cell stack with horizontal cell orientation.

If the liquid outlet is formed in the liquid-collecting region so that it can be used for outlet of liquid from the liquid separator in a first orientation of the liquid separator and in a second orientation of the liquid separator, tilted by 90° relative to the first orientation, the liquid separator can be fitted equally easily in fuel cell stacks with vertical and in fuel cell stacks with horizontal cell orientation. The liquid separator can then be used universally in fuel cell stacks with vertical and horizontal cell orientation. This reduces the production cost since no adaptation to the vertical or horizontal stack form is necessary.

Preferably, the liquid separator according to the invention has an inlet arranged above the liquid-collecting region. The inlet may for example be equipped with a purge valve. The term “above” relates to at least one of the two said orientations of the liquid separator. The liquid separator according to the invention thus comprises an inlet arranged above the liquid-collecting region when, in one of the two orientations of the liquid separator, the inlet can come to lie above a surface of a liquid which can collect in the liquid-collecting region at the liquid outlet. The term “above” preferably refers to both above-mentioned orientations of the liquid separator. The liquid separator according to the invention thus comprises an inlet arranged above the liquid-collecting region when, in both orientations of the liquid separator, the inlet can come to lie above a surface of a liquid which can collect in the liquid-collecting region at the liquid outlet.

Preferably, there is no edge to be overcome by a captured liquid when flowing into the liquid passage at a transition from the catchment region to the liquid passage. Since there is no edge in the transition, the adhesion forces are retained and the liquid is dragged into the liquid-collecting region. This leads to an even more reliable discharge of surplus liquid from the fluid-conducting channel.

In a liquid separator according to the invention, the fluid-conducting channel may have at least one first portion with widened channel cross-section, and/or at least part of the catchment region may be formed at a first channel wall portion lying in this first portion. The first portion may transform into a second portion of the fluid-conducting channel with smaller cross-section. A liquid barrier is preferably formed at the transition from the first portion to the second portion.

Preferably, a curvature of the fluid-conducting channel with smaller cross-section opens into the first portion with widened channel cross-section.

The invention also concerns a method for separating liquid, for example a watery liquid, from a fluid, wherein the liquid is separated from the fluid in a fluid-conducting channel and the separated liquid is conveyed via a liquid passage branching from the fluid-conducting channel into a liquid-collecting region and collected therein.

The fluid may contain at least 10 vol. %, preferably at least 30 vol. %, particularly preferably at least 70 vol. % of a gaseous fuel, e.g. H₂. Thus anode gases to be recycled from multiple fuel cells are combined.

The method according to the invention is preferably a method for separating a watery liquid from a gas, wherein the gas is formed at least partly from a gas stream obtained from a fuel cell stack and containing at least 10 vol. % H₂.

The fluid may alternatively contain air for example. The air may e.g. be at least partly cleared of suspended matter in an upstream cleaning step.

The invention also concerns a fluid-guiding unit for a fuel cell device, comprising a liquid separator according to the invention. The fluid-conducting channel may be received in a body such that a body floor element forms a floor of the liquid-collecting region.

Alternatively, a floor element may be arranged on at least one channel base element. The floor element then forms a floor of the liquid-collecting region.

If the fluid-conducting channel is received in a body such that a body floor element forms a floor of the liquid-collecting region, the liquid outlet may preferably be formed by the body floor element.

If a floor element is arranged on at least one channel base element, and the floor element forms a floor of the liquid-collecting region, the liquid outlet may preferably be formed by the floor element.

The liquid separator is typically stationary relative to the other components of the fluid-guiding unit. The description above, relating to two different orientations of the liquid separator and the outlet of liquid through the liquid outlet, preferably also applies if the liquid outlet is formed by the body floor element or by the floor element.

The liquid outlet may be formed in the liquid-collecting region such that it can be used for outlet of liquid from the fluid-guiding unit in a first orientation of the fluid-guiding unit and in a second orientation of the fluid-guiding unit. The second orientation is tilted preferably by 90° relative to the first orientation.

In the fluid-guiding unit, the inlet arranged above the liquid-collecting region may lead into the fluid-guiding unit. The inlet may e.g. pass through a wall region which at least partially isolates the interior of the fluid-guiding unit from the surrounding atmosphere.

The invention also concerns a component for production of a liquid separator according to the invention or a fluid-guiding unit according to the invention, wherein the component comprises a part of a fluid-conducting channel and at least a part of a liquid passage branching from the part of the fluid-conducting channel.

It may be favorable if the component furthermore comprises the following:
at least a part of a floor element which forms a floor of a liquid-collecting region and into which the liquid passage or the part of the liquid passage opens, and/or at least a part of a liquid-conducting element leading to the liquid passage or to the part of the liquid passage.

The part of the fluid-conducting channel preferably has at least one curvature.

It is preferred that the component can be obtained or produced by injection-molding.

The invention also concerns a component set for production of a liquid separator according to the invention or a fluid-guiding unit according to the invention. Preferably, the component set is an injection-molding component set. Preferably, the components can be obtained or produced by injection-molding.

Features of the invention described in conjunction with a subject of the invention, i.e. in conjunction with the liquid separator, fluid-guiding unit, method, component or component set according to the invention, preferably apply also to every other subject of the invention.

Further preferred features and/or advantages of the invention are the subject of the following description and illustrations of exemplary embodiments.

### BRIEF DESCRIPTION OF THE DRAWINGS

FIG. 1 shows a schematic, perspective, sectional illustration of a liquid separator;

FIG. 2 shows a schematic, perspective illustration of a liquid separator with helical fluid-conducting channel;

FIG. 3 shows a schematic illustration of a liquid separator with curved fluid-conducting channel;

FIG. 4 shows a schematic illustration of a liquid separator without liquid passage according to the invention;

FIG. 5 shows a schematic illustration of a liquid separator with liquid passage according to the invention;

FIG. 6 shows a schematic illustration of a liquid separator with baffle panel elements;

FIG. 7 shows a schematic illustration of a liquid separator with barrier panel elements;

FIG. 8 shows a schematic illustration of the function of the liquid separator from FIG. 7 in a tilted vehicle;

FIGS. 9, 10 show schematic illustrations of different liquid separators with labyrinth paths defined by ribs;

FIG. 11 shows a schematic illustration of a liquid separator with inlet arranged above the liquid-collecting region and liquid outlet formed in the liquid-collecting region;

FIG. 12 shows an enlarged, schematic illustration of the liquid outlet from FIG. 11;

FIG. 13 shows a schematic, sectional illustration of a part region of a liquid separator without edge at the transition to the liquid passage;

FIG. 14 shows a schematic, sectional illustration of a part region of a liquid separator with different channel cross-sections and liquid barriers;

FIGS. 15A, B show schematic, sectional illustrations of part regions of liquid separators with curvatures and different channel cross-sections;

FIG. 16 shows a schematic, sectional illustration of a part region of a gas-conveying device and a gas distribution layer of a fuel cell;

FIGS. 17-19 show schematic, perspective illustrations of a channel cover element and a channel base element, and a fluid-conducting channel formed thereby;

FIGS. 20-24 show schematic, perspective illustrations of a fluid-guiding unit, wherein the fluid-conducting channel formed according to FIGS. 17-19 is received in a body;

FIGS. 25-26 show a schematic, vertical section through the fluid-guiding unit from FIGS. 20-24 along line 1-1 in FIG. 24, in two different perspective illustrations;

FIGS. 27, 28 show schematic, perspective illustrations of the fluid-guiding unit from FIGS. 20-24 without channel cover element;

FIGS. 29, 30 show a schematic, vertical section through the fluid-guiding unit from FIGS. 27 and 28 along the line 2-2 in FIG. 28, in two different perspective illustrations;

FIGS. 31-35 show schematic, perspective illustrations of a channel base element and a floor element arranged thereon;

FIGS. 36-39 show schematic, perspective illustrations of a fluid-guiding unit, wherein the fluid-conducting channel is formed from the channel base element in FIGS. 31-35 and a channel cover element functioning as a body;

FIG. 40 shows a schematic, vertical section through the fluid-guiding unit from FIGS. 36-39 along the line 3-3 in FIG. 39, in two different perspective illustrations;

FIGS. 41-44 show schematic, perspective illustrations of the channel cover element of the fluid-guiding unit from FIGS. 36-39;

FIGS. 45, 46 show two schematic, vertical sections through the channel cover element from FIGS. 41-44 along lines 4-4 and 5-5 in FIG. 44.

The same or functionally equivalent elements carry the same reference signs in all figures.

### DETAILED DESCRIPTION OF THE DRAWINGS

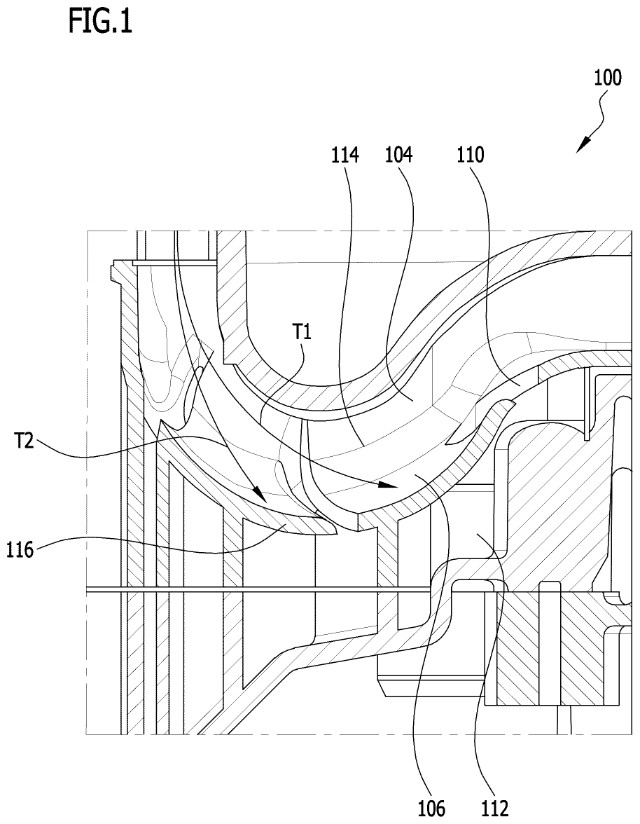

The embodiments of the invention shown in FIGS. 1 to 3 and 5 to 14 comprise various liquid separators 100. These are particularly suitable for fuel cell devices. They are however also suitable for liquid separation in other devices.

The liquid separators 100 shown in these figures each comprise a fluid-conducting channel 104. They also comprise a catchment region 106 for capturing liquid from a fluid which can be conveyed in the fluid-conducting channel 104. They also comprise a liquid passage 110 branching from the fluid-conducting channel 104, and a liquid-collecting region 112 into which the liquid passage 110 opens.

In the liquid separator 100 shown in FIG. 1, the fluid-conducting channel 104 has a curvature 114. Catchment regions, of which only one is marked with reference sign 106, are formed on a channel wall 116 of the fluid-conducting channel 104 lying radially on the outside in the flow direction of the fluid.

FIG. 1 illustrates how drops are precipitated in liquid separators 106 with curvature 114 according to the invention. Larger drops in the flowing fluid are driven particularly more strongly towards the radially outer channel wall in the region of the curvature 114 and often precipitated at catchment regions 106 lying further upstream. This is shown in simplified form by trajectory T1. Smaller droplets in the flowing fluid are driven less strongly towards the radially outer channel wall 116 in the region of the curvature 114 and often precipitated only at catchment regions 106 lying further downstream. This is shown in simplified form by trajectory T2. The captured liquid is driven from the catchment regions 106 by the fluid flowing in the fluid-conducting channel 104 towards the nearest liquid passage downstream, so that the captured liquid flows to the liquid passage 110 and through the liquid passage into the liquid-collecting region 112 with no or much weaker through-flow.

In other words, the drops hit the channel wall 116, where they accumulate into a liquid film or moisten the catchment regions 106. The flow or resulting shear forces drive the film into the liquid passages 110, wherein on passing through the liquid passages 110, the liquid breaks away and enters the liquid-collecting region 112.

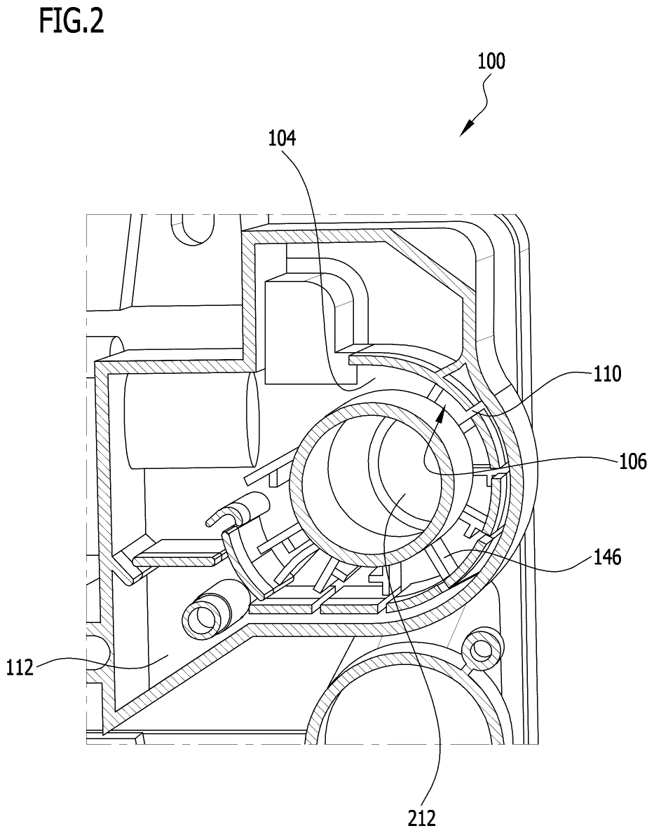

The liquid separator 100 shown in FIG. 2 has a helical fluid-conducting channel 104. In the example shown here, the fluid-conducting channel is formed as a spiral around a channel which defines a coolant-guiding zone 212. Also, in the example shown here, liquid-conducting elements 146 are provided which lead towards liquid passages 110.

The liquid-collecting region 112 extends on the outside of the channel wall and connects the liquid passages 110 outside the fluid-conducting channel 104. The liquid is thus discharged through a double floor.

The liquid passages may alternatively also be defined by the openings between the fibers of a fleece. The fleece could for example be arranged inside the liquid passages 110 shown in FIG. 2.

The helical guidance allows a strong curvature to be achieved particularly easily, so that the separation power is increased. The fluid deflection is more than 180°, leading to a cross-flow viewed along the helix axis.

Because of the helical curvature, the crossing flow profiles are situated in different planes. By deviation from the illustration in FIG. 2, the helical fluid-conducting channel may also be formed without the liquid-conducting elements 146. Instead or in addition, the boundary of the fluid-conducting channel remote from the observer may rise with the fluid-conducting channel.

Because of the helical guidance around the coolant-guiding zone 212, condensation on the radially inner channel wall can be avoided. Any condensate forming there would otherwise be difficult to remove because of the fully circumferential flow.

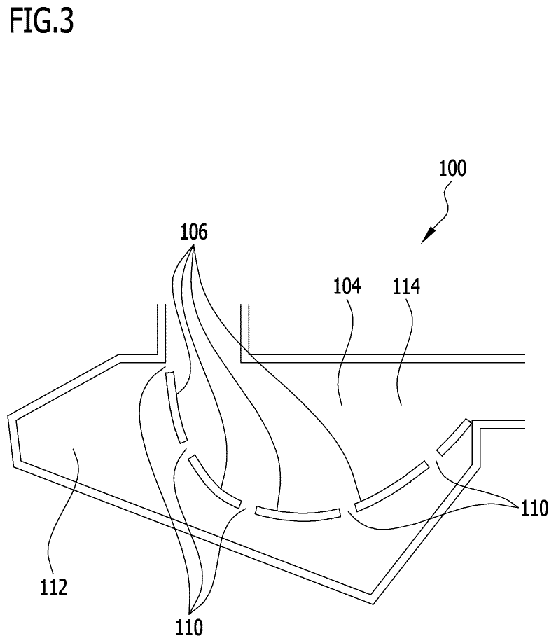

FIG. 3 shows how a liquid-collecting region 112 may be arranged for example relative to the fluid-conducting channel 104, catchment regions 106 and liquid passages 110.

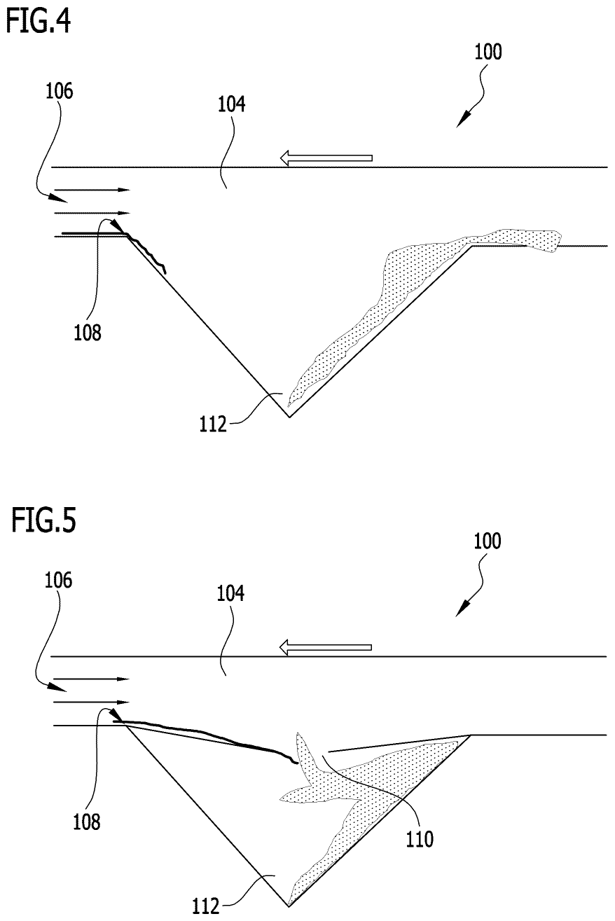

FIG. 4 illustrates how liquid, which has flowed out of a catchment region 106 via an outflow zone 108 into a liquid-collecting region 112, can flow back into a fluid-conducting channel 104 of a liquid separator 100 if the liquid-collecting region 112 is open towards the fluid-conducting channel 104. If a force acts on a liquid standing in the liquid-collecting region 112, in the direction shown by the arrow, the liquid sloshes into the fluid-conducting channel 104 and in the worst case is conveyed with the fluid guided therein into the fuel cell stack. If the liquid enters the fluid stream of the fluid-conducting channel, it is then in any case atomized by the high active shear forces, or carried in the direction of the fluid outlet.

FIGS. 5 to 10 illustrate exemplary embodiments of the invention for keeping the liquid in the liquid-collecting region even under active forces, e.g. on deceleration, acceleration or cornering.

In the liquid separator 100 in FIG. 5, channel wall portions slope towards the liquid passage 110.

The two channel wall portions retain a large part of the liquid in the liquid-collecting region 112. This is advantageous on deceleration, acceleration or cornering. Part of the collected liquid does not flow back into the fluid-conducting channel 104.

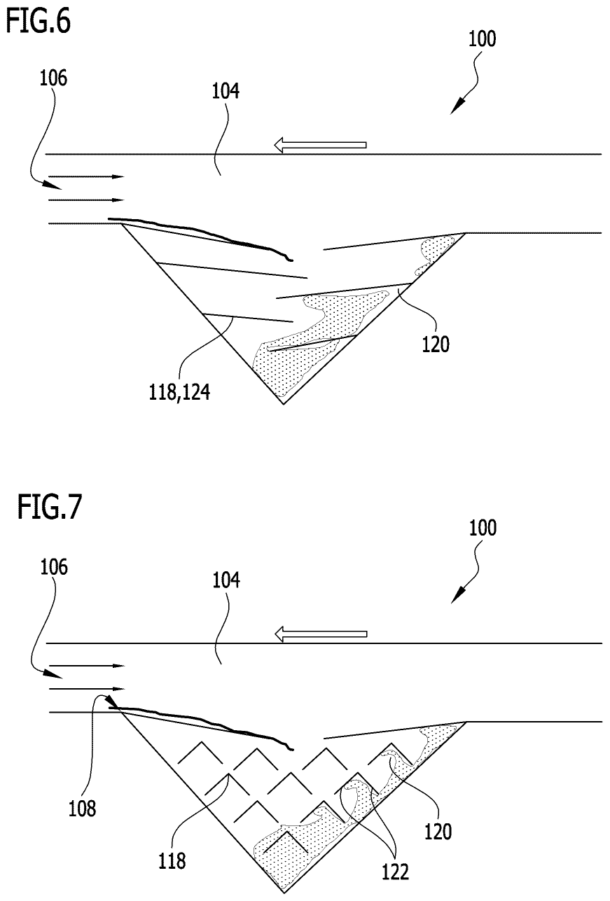

FIGS. 6 to 10 show embodiments with additional backflow barriers 118. These define deflection regions 120 which open towards the liquid-collecting region 112.

The deflection region 120 may be screened from the fluid-conducting channel 104 by one or more baffle panel elements 124, as shown in FIG. 6. Deflection regions 120 opening towards the liquid-collecting region 112 may for example be formed at the transition of the baffle panel elements into a wall of the liquid-collecting region 112, as also shown in FIG. 6.

Alternatively, a deflection region 120 may be screened from the fluid-conducting channel 104 for example by barrier panel elements 122 sloping relative to one another, as shown in FIG. 7. Deflection regions 120 opening towards the liquid-collecting region 112 may for example be formed at the transition between two barrier panel elements 122 sloping relative to one another, as also shown in FIG. 7.

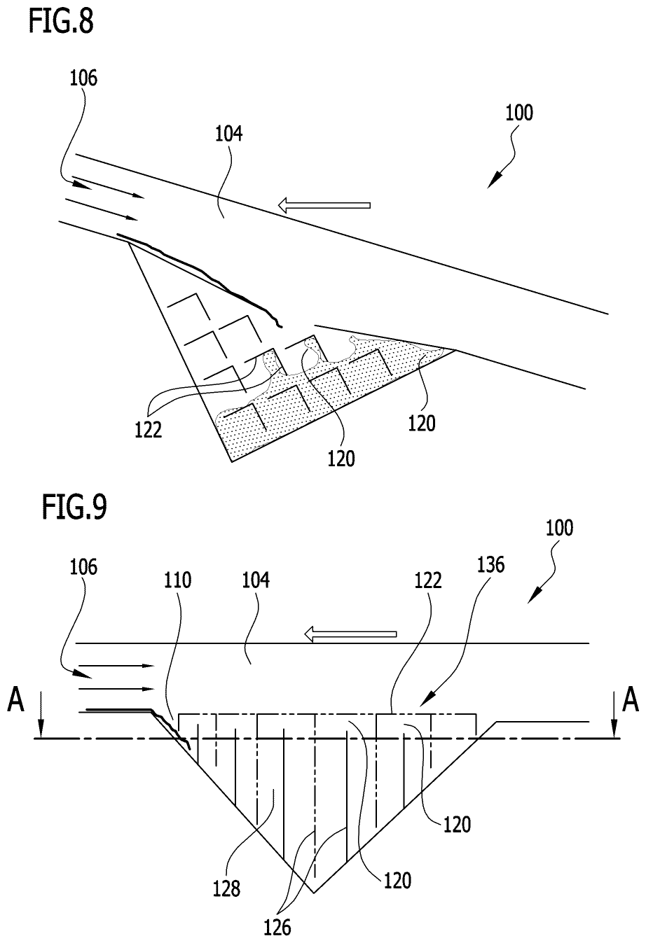

FIG. 8 illustrates the function of backflow barriers 118, barrier panel elements 122 and the deflection regions 120 formed thereby in the embodiment of FIG. 7. They effectively prevent a backflow of fluid into the liquid-conducting channel 104 under forces occurring during a tilting of the vehicle and/or on deceleration, acceleration or cornering.

A deflection region 120 may also be screened from the fluid-conducting channel 104 for example by a barrier panel element 122 oriented substantially parallel to the adjacent fluid-conducting channel portion, as shown in FIG. 9. In FIG. 9, the barrier panel element forms part of a backflow barrier insert 136.

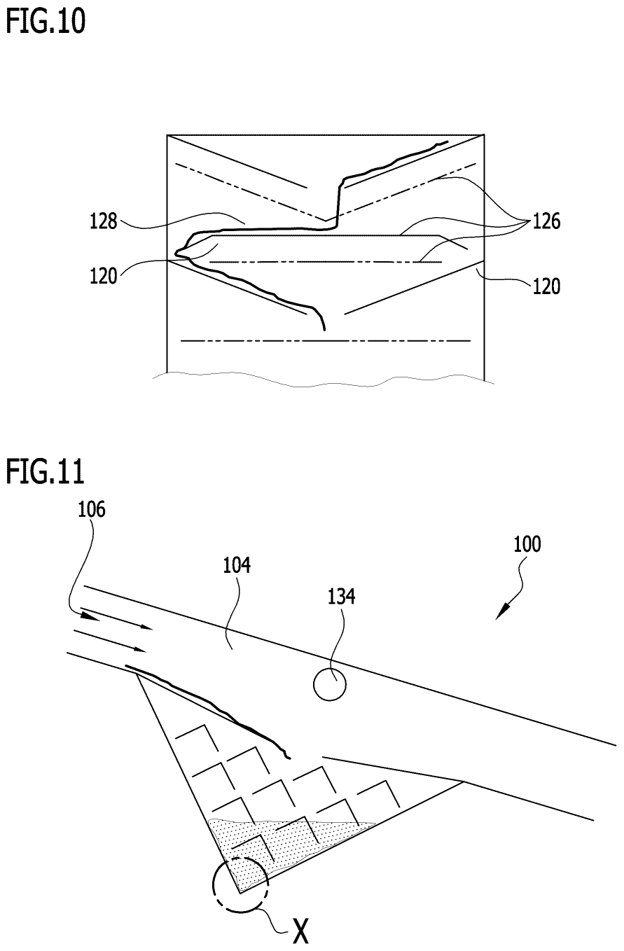

The embodiments of FIGS. 9 and 10 have ribs 126. These define a labyrinth path 128 which runs into the liquid-collecting region 112 or inside the liquid-collecting region 112. In the embodiment of FIG. 9, the ribs 126 run substantially vertically. In the embodiment of FIG. 10, the ribs 128 run substantially horizontally.

Preferably, the backflow barriers 118, barrier panel elements 122 and baffle panel elements 124 are arranged such that they can be obtained by injection-molding. At least part of their surfaces preferably runs in the direction of removal from a shell using injection-molding. Depending on design of the mold, it is possible in a particularly simple fashion to finely divide the liquid-collecting region 112 into many small sub-regions, so that splashing and the associated risk of backflow of liquid into the fluid-conducting channel 104 are further minimized with the lowest possible cost.

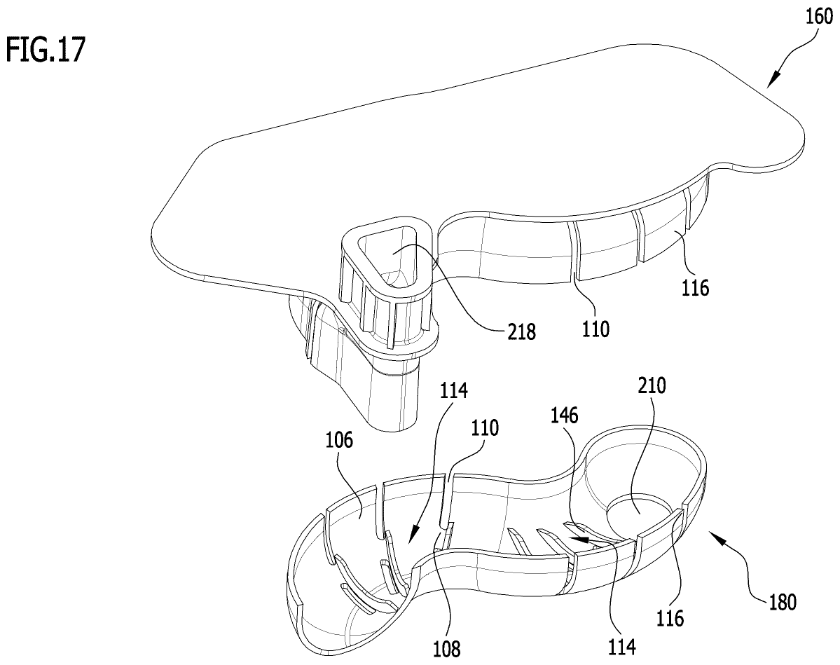

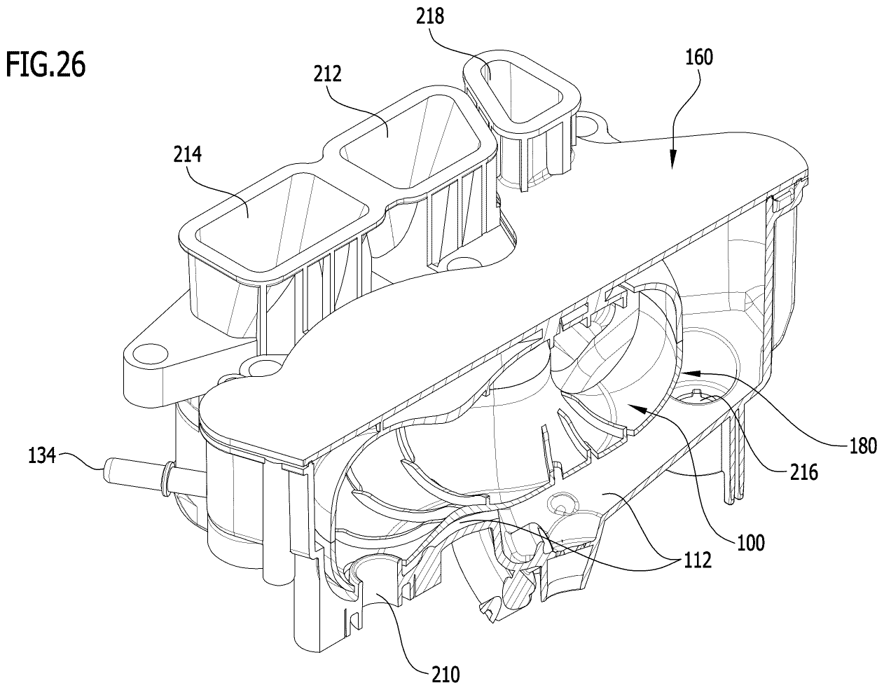

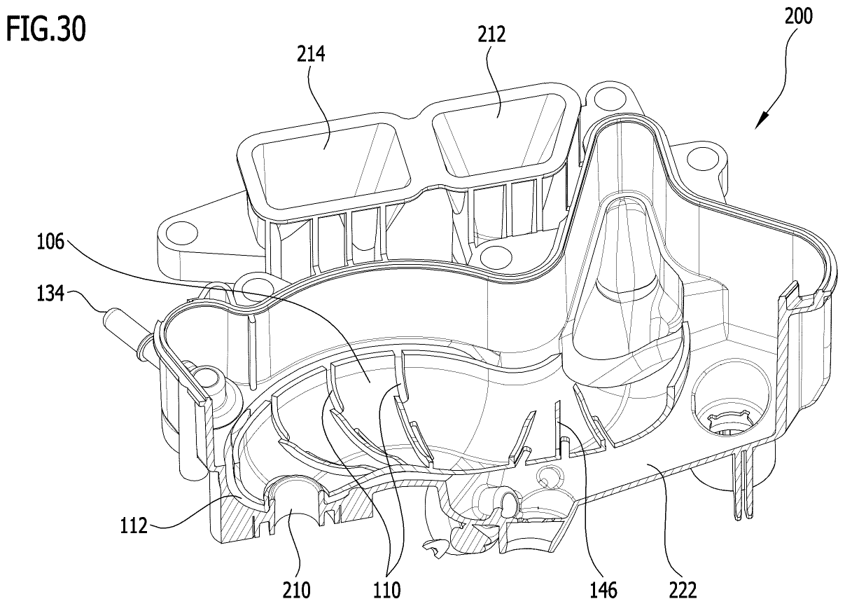

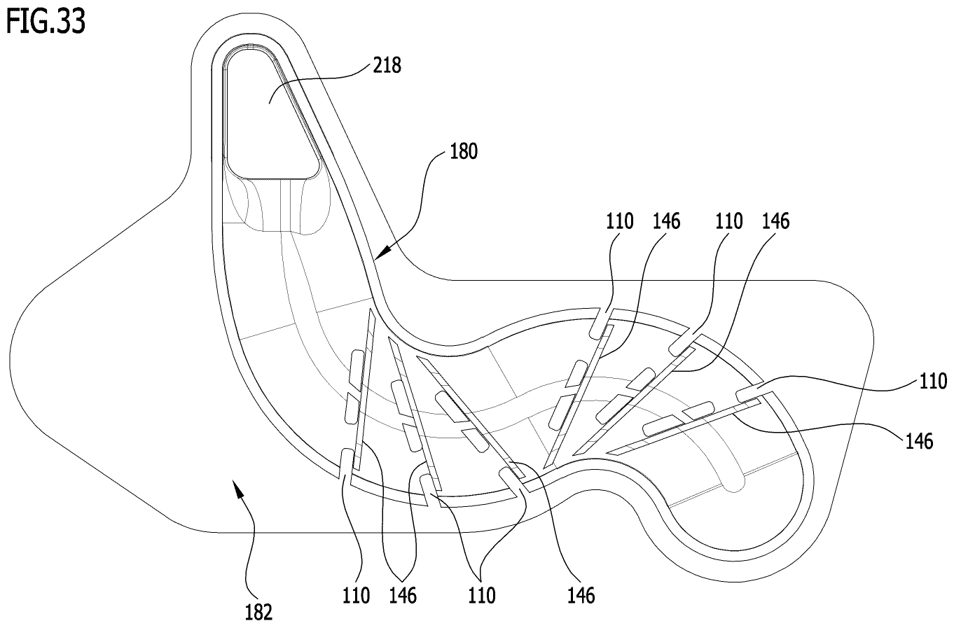

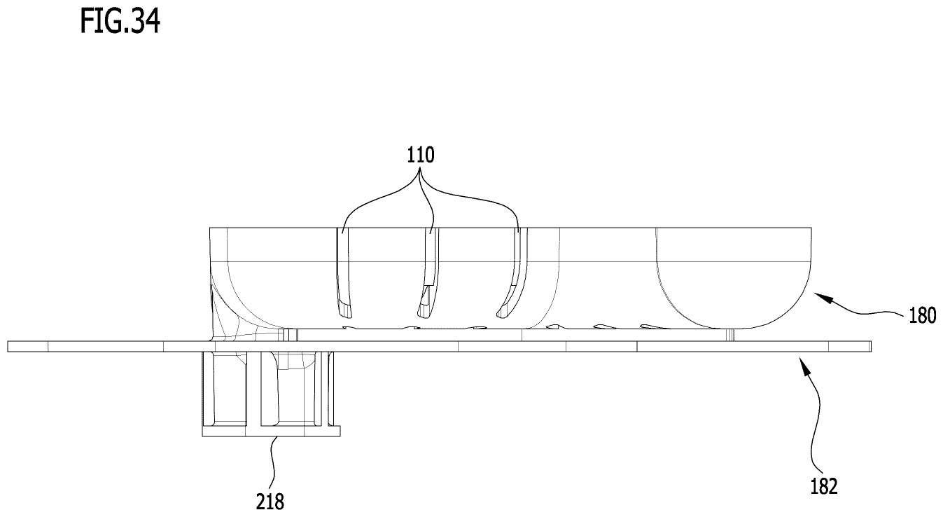

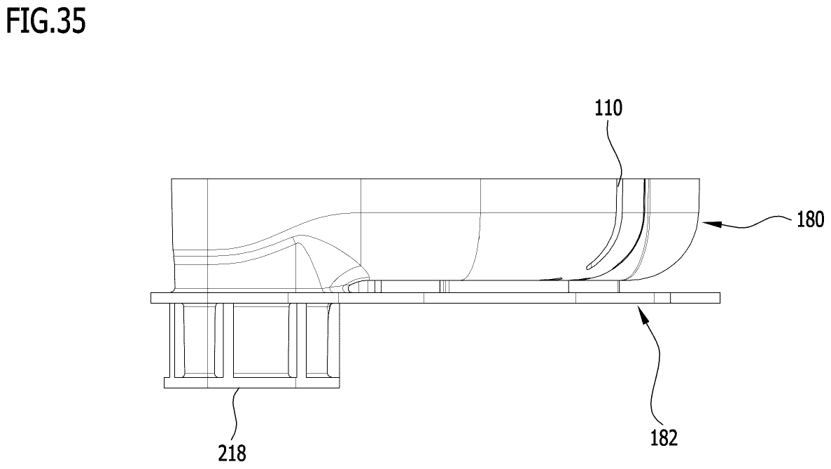

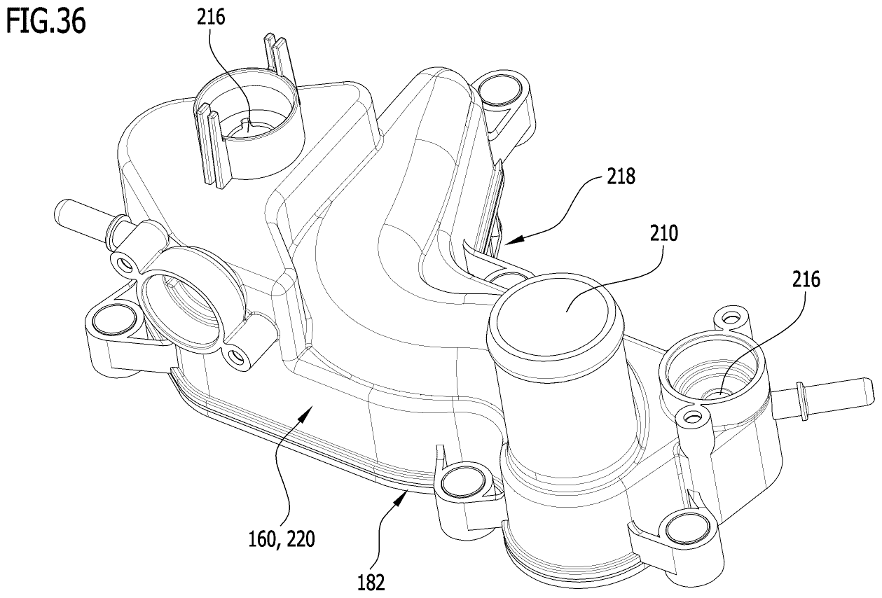

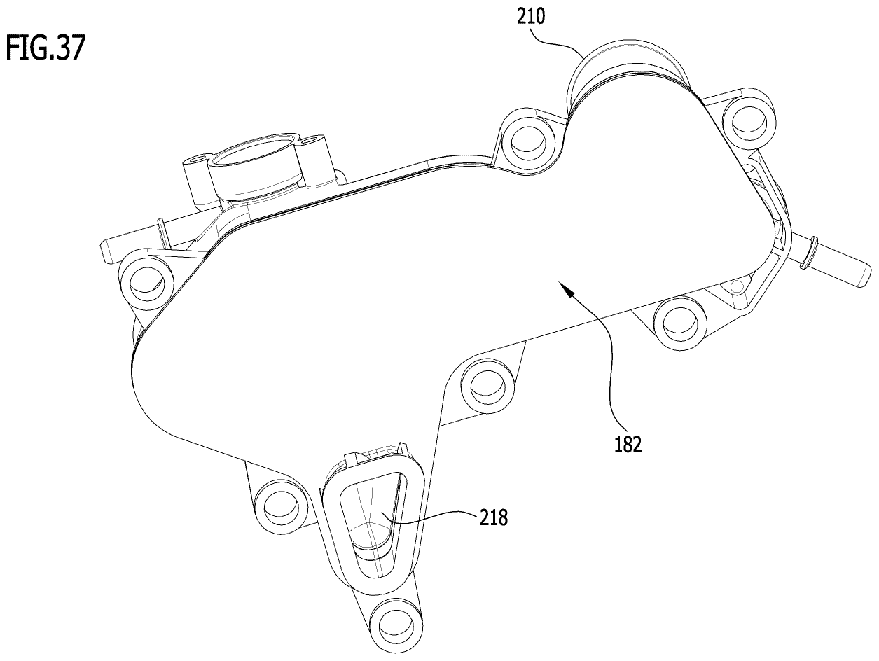

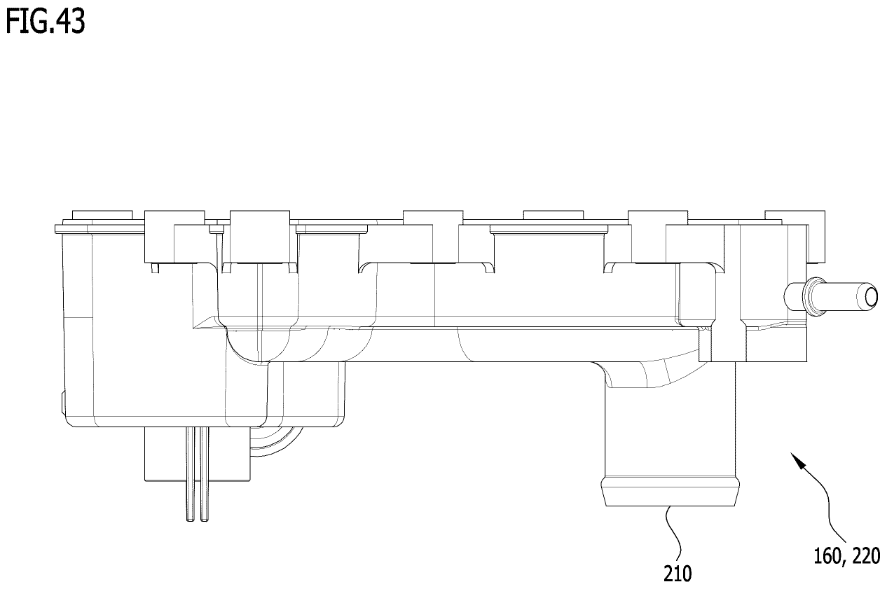

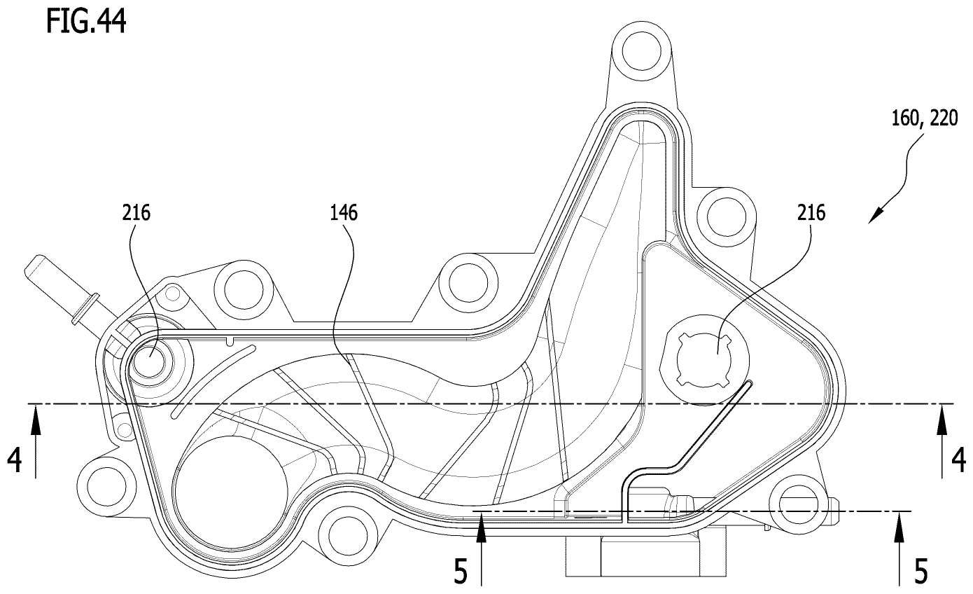

It is clear from the two embodiments of liquid separators 100 according to the invention which are described in more detail below, with reference to FIGS. 17 to 30 and 31 to 46, that the fluid-conducting channel 104 may be defined by at least two components which can be produced by injection-molding, the so-called channel base element 180 and the so-called channel cover element 160.

Depending on the proposed direction of removal from the mold, in principle it is possible to arrange backflow barriers 118, barrier panel elements 122 and baffle panel elements 124 so that they are formed by injection-molding at least partially directly on the channel base element 180 and channel cover element 160. The same applies to the liquid-conducting elements 146.

Also, a further separate component may also be produced for example by injection-molding, e.g. an insert with the barrier panel element 122 shown in FIG. 9 and the ribs 126 extending from this barrier panel element. On later assembly of the fluid-conducting channel 104, liquid separator 100 or fluid-guiding unit 200, the insert may be introduced between the channel base element 180 and the channel cover element 160, or also between at least one of these elements and a body 220, which is described below in more detail with reference to FIGS. 17 to 46.

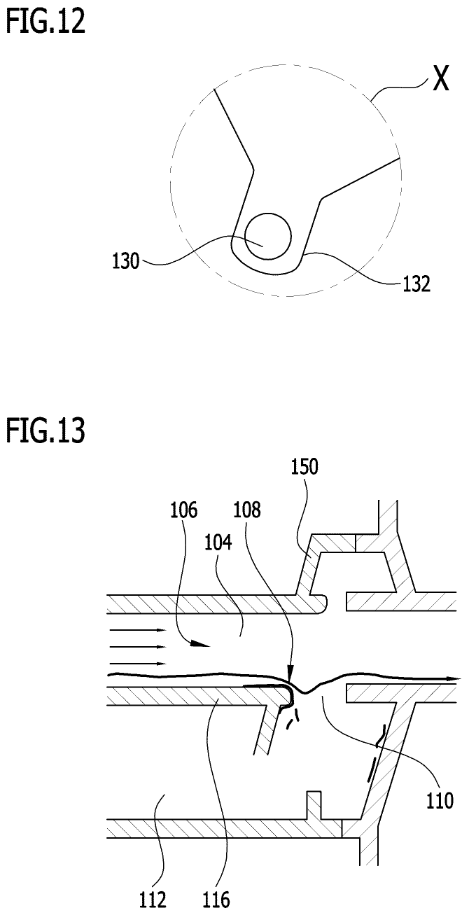

FIGS. 11 and 12 also show a liquid outlet 130 formed in the liquid-collecting region 112. This may assume an open or closed state, which for example can be achieved by a drainage valve (not shown here). FIG. 12 shows an enlarged extract X from FIG. 11. The liquid outlet 130 is arranged in an outlet region 132, shown in FIG. 12, which branches downward from the liquid-collecting region 112. The largest cross-section of the outlet region does not exceed 2 cm², preferably 1 cm², for example 0.5 cm².

The outlet region 132 is for example a blind depression, the walls of which are so steep and the diameter so small that it forms the lowest point of the liquid-collecting region 112. Its volume is preferably minimal. The depth of the blind depression may for example be 6 mm. Thus always only a very small volume of liquid may remain there when liquid has been drained through the drainage valve.

FIG. 11 also shows an inlet 134 arranged above the liquid-collecting region 112. This too may assume an open or a closed state, which can be achieved for example by a purge valve (not shown here). The inlet is arranged in an upper region/gas-conveying region of the liquid separator, so that no liquid collects in the region of the inlet 134.

When the liquid in the liquid-collecting region 112 exceeds a specific level, the drainage valve may be opened for a moment and the liquid drained through the liquid outlet 130 without the escape of significant quantities of a fluid conveyed in the fluid channel, e.g. an H₂-containing gas.

FIG. 13 shows a part region of a liquid separator. A transition from the catchment region 106 to the liquid passage 110 forms an outflow zone 108. Captured liquid can flow to the liquid passage 110 through this outflow zone. Outflow takes place against the force of gravity in the orientation shown. Captured liquid is carried on the surface of the channel wall 116 by fluid flowing in the fluid-conducting channel 104.

In the embodiment shown in FIG. 13, there is no edge at the transition from the catchment region 106 to the liquid passage 110. The captured fluid need not then overcome an edge on its outflow into the liquid passage 110.

In the embodiment shown in FIG. 13, the liquid passage 110 is formed running around the channel wall. The circumferential liquid passage 110 serves to convey liquid, which has been captured in the catchment region 106 and carried along the channel surface, into a rest region without through-flow. This transforms into a liquid-collecting region 112. Since there is no edge at the transition, the adhesion forces are retained and the liquid is carried into the liquid-collecting region 112.

The sectional illustration does not show that the rest region runs around the fluid-conducting channel 104 on the outer surface of the channel wall. Liquid which initially enters the rest region to the left through the liquid passage then flows around the fluid-conducting channel on a sloping runout surface 150. Thus the liquid finally reaches the liquid-collecting region 112 shown on the right in FIG. 13.

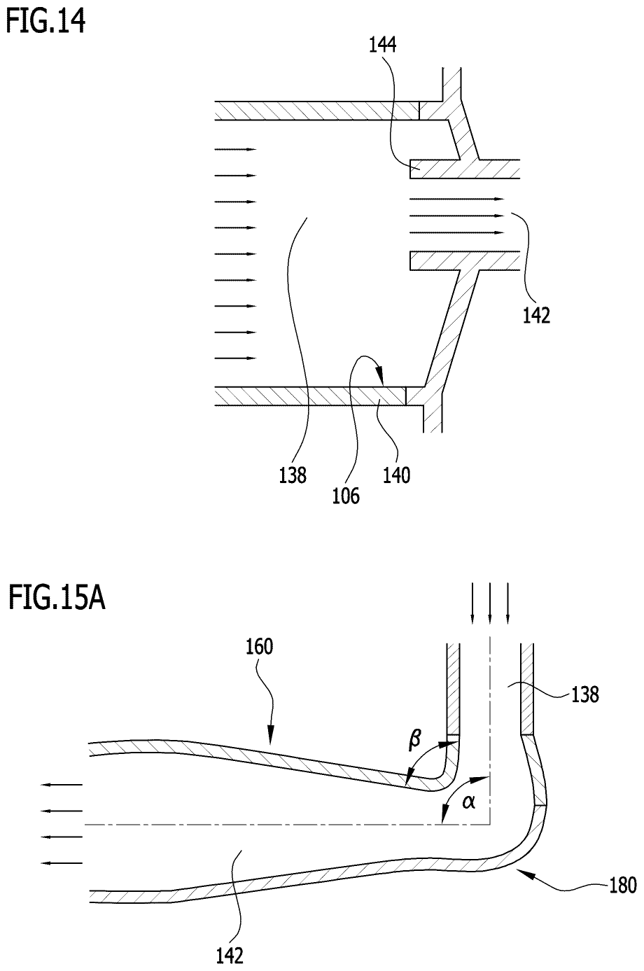

FIG. 14 shows a section through a portion of a fluid-conducting channel. The fluid-conducting channel has a first portion 138 with wider channel cross-section. The catchment region 106 is formed on a first channel wall portion 140 lying in this first portion 138. The first portion 138 transforms into a second portion 142 of the fluid-conducting channel 104 with smaller cross-section. A liquid barrier 144 is formed at the transition from the first portion 138 to the second portion 142.

The flow speed is low in the edge regions of the portion 138 with wider channel cross-section. Accordingly, the shear forces are so low that liquid on the surface of the channel wall is not carried along by upwardly flowing fluid.

In addition, the liquid barrier 144 ensures that any liquid which is carried along cannot penetrate the second portion 142 of the fluid-conducting channel with smaller cross-section.

The liquid barrier 144 may for example be formed by an end of the line which forms the second portion 142, wherein the end extends into the first portion 138 as shown in FIG. 14. Such an arrangement, in the manner of an immersion tube directed against the flow, allows particularly simple creation of a liquid barrier.

In the liquid separator from FIG. 14, the liquid passage 110 may be formed upstream in a portion not shown here. Then liquid flowing under force of gravity can reach the liquid passage along the inner surface of the first channel wall portion 140.

The schematic sectional illustrations in FIGS. 15A and 15B also show part regions of liquid separators with different channel cross-sections. These also have curvatures. Thus in connection with the invention, pressure losses may be minimized. Also, the part regions shown here can be produced particularly easily from multiple components obtainable by injection-molding, e.g. a channel cover element 160 and a channel base element 180.

By suitable deflection and widening, for example with fluid-conducting channel portions as shown in FIGS. 15A and 15B, pressure losses can be minimized. Thus regions in which liquid can undesirably collect or accumulate can be reduced, and friction losses between flow and walls reduced.

With a multi-piece construction, this can advantageously be replicated in the injection-molding process. An upper shell may for example also form a channel cover element 160. It defines a channel portion running from top to bottom in the illustration of FIG. 15A, which widens already before the deflection. The deflection furthermore comprises an inner radius on the channel cover element 160 which is selected sufficiently large to avoid an undesirable collection or accumulation of liquid (“flow-optimized elbow”). The deflection angle for a deflection of 90° preferably amounts to more than 270°, as indicated by the angles alpha and beta in FIG. 15A.

The upper and lower shells, or channel cover element 160 and channel base element 180, preferably form a diffuser which avoids/minimizes pressure losses (see above).

Peripheral conditions, such as e.g. the cross-section of a distributor for a fuel cells stack and a restricted installation height, may mean that a rapidly flowing fluid must be deflected within a small installation height. Here it may be suitable to deflect the fluid as described in connection with FIG. 15A.

FIG. 15B shows on the left side an additional deflection which is simultaneously widened. Transitions between the upper and lower shells (here illustrated unseparated), or channel cover element 160 and channel base element 180, may lie for example as in FIG. 15A.

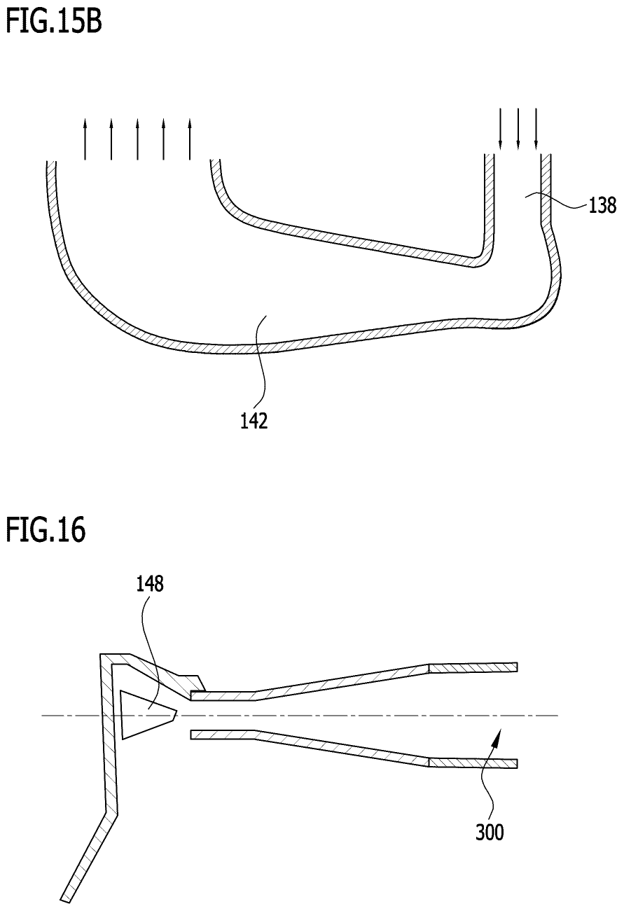

FIG. 16 shows schematically a gas-conveying device 148 and a gas distribution layer 300 of a fuel cell, as may be arranged for example downstream of the fluid separator according to the invention, in order to conduct or recycle H₂ into the fuel cell stack.

Preferably, the H₂ outlet from the gas-conveying device 148—which may for example be an ejector—is coaxial or only slightly tilted relative to the inlet into the gas distribution layer. Because of the maximum mass flow, this is a structure in which the lowest pressure losses occur.

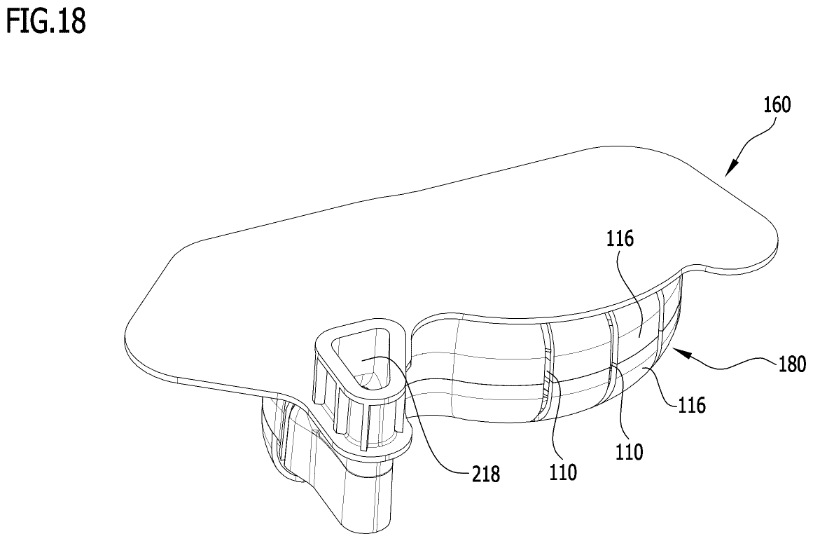

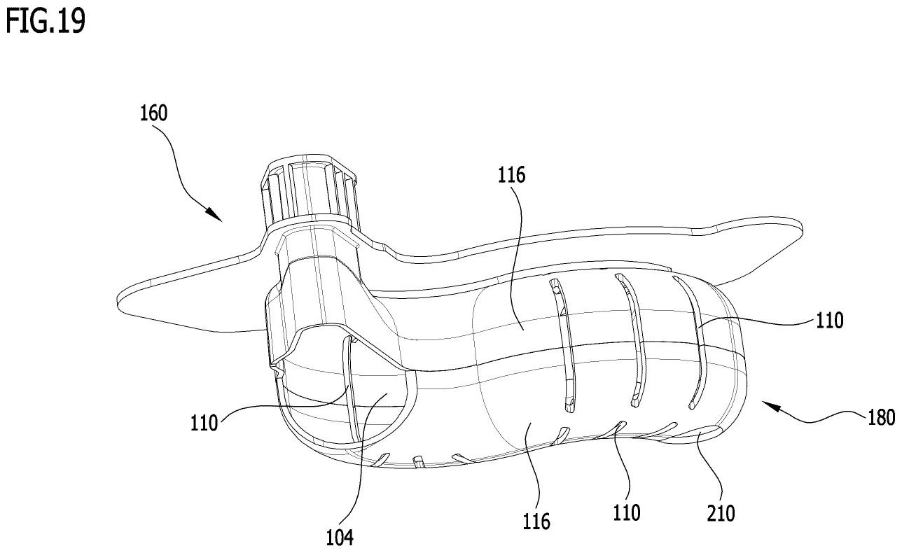

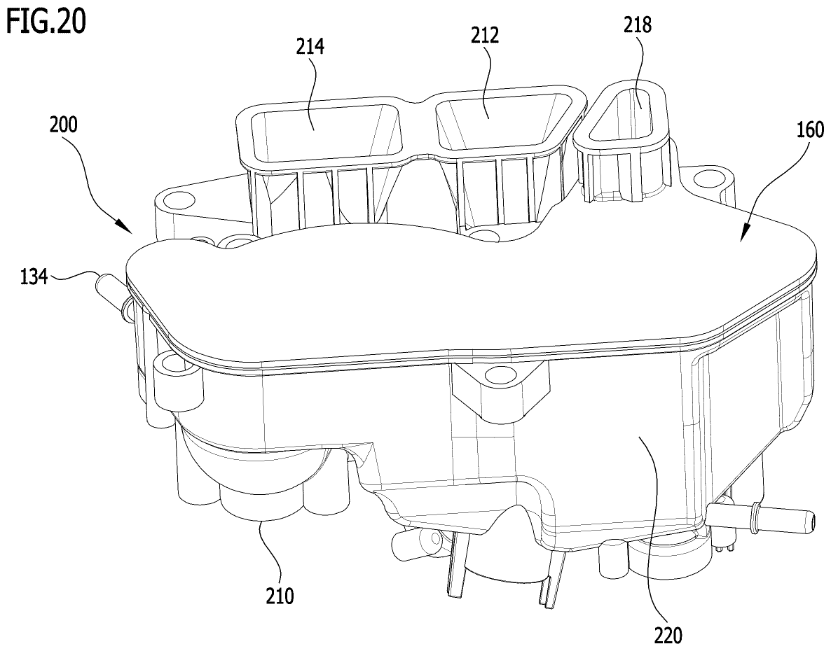

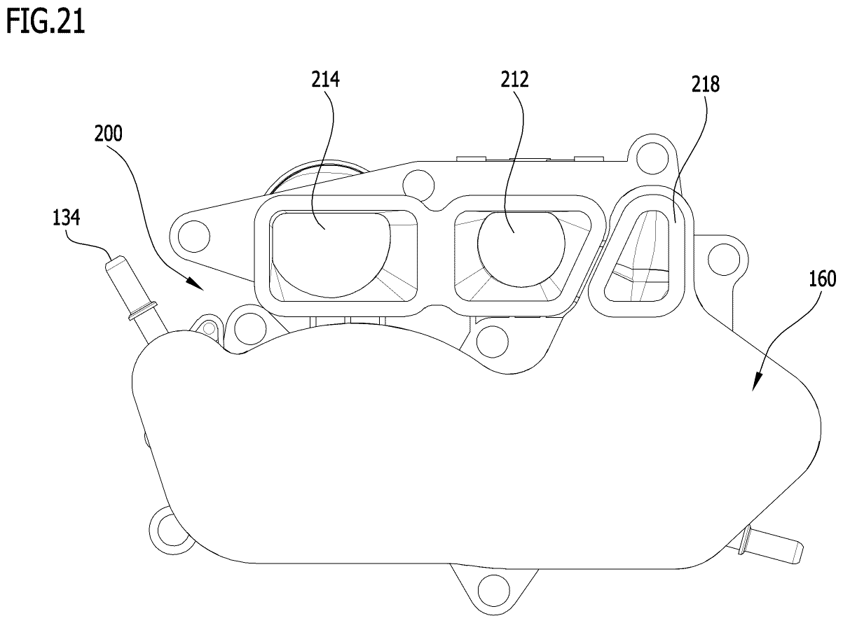

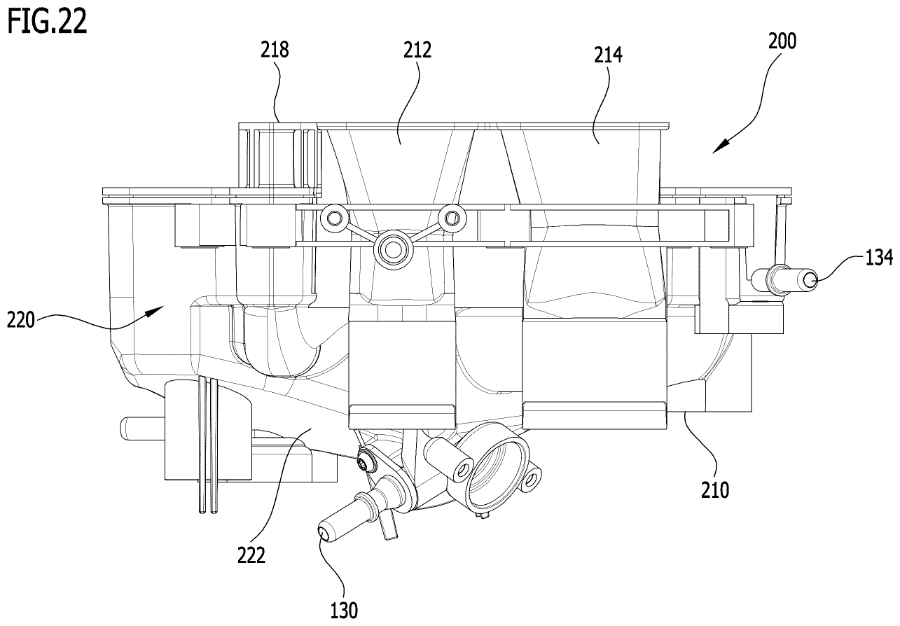

FIG. 17 shows a channel cover element 160 and a channel base element 180 for a first embodiment of a liquid separator according to the invention, and for a first embodiment of a fluid-guiding unit 200 according to the invention. FIGS. 18 and 19 shows a fluid-conducting channel 104 formed with these elements 160 and 180.

The channel cover element 160, shown at the top in FIG. 17, has a fluid inlet 218 and a part of the liquid passages 110. The channel base element 180, shown at the bottom in FIG. 17, has a fluid outlet 210, another part of the liquid passages 110, and liquid-conducting elements 146.

One of the catchment regions 106 for capturing liquid from a fluid conveyed in the fluid-conducting channel 104 is identified in FIG. 17 on the channel base element 180. The catchment regions evidently also extend into the adjacent regions of the channel cover element 160. There however they are not marked with reference signs since the corresponding surfaces of the channel cover element 160 are covered in the perspective of FIG. 17. The same applies to the catchment regions which are formed in the curvature 114 lying closer to the fluid outlet 210, on the radially outer channel wall 116 in the flow direction of the fluid.

As evident from FIG. 17, a transition from the catchment region 106 to the liquid passage 110 forms an outflow zone 108. A liquid captured in the catchment region 106 can flow out through the outflow zone to the liquid passage 110.

FIG. 19 clearly shows that a part of the liquid passages 110 is formed on an underside of the channel wall 116.

FIGS. 20 to 24 show schematic, perspective illustrations of a fluid-guiding unit 200. A fluid-guiding unit 200 comprises a body 220 which receives the fluid-conducting channel formed according to FIGS. 17 to 19.

The fluid-guiding unit 200 has a coolant-guiding zone 212, an air-conducting zone 214, a liquid outlet 130 and an inlet 134. The liquid outlet 130 may for example be equipped with a drainage valve. The inlet 134 may for example be equipped with a purge valve.

In the fluid-guiding unit 200 of FIGS. 20-24, the fluid-conducting channel 104 is received in a body 220 such that a body floor element 222 (visible in FIGS. 22 to 24) forms a floor of the liquid-collecting region 112.

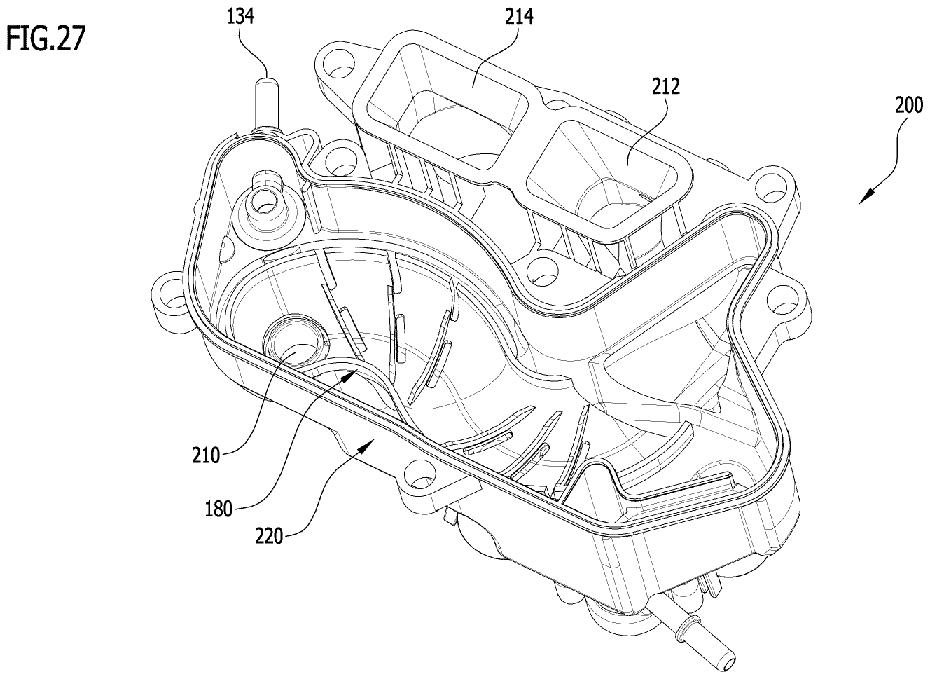

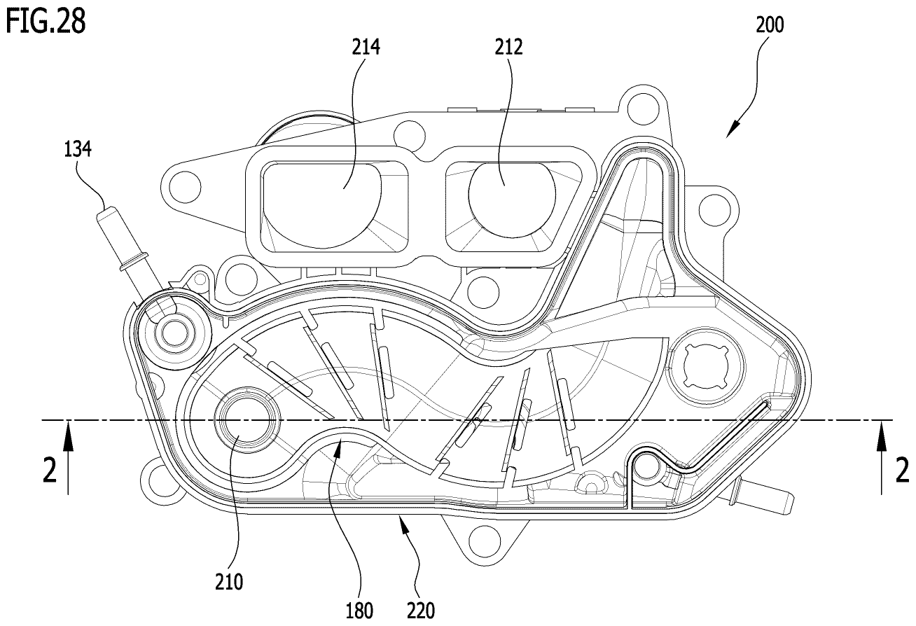

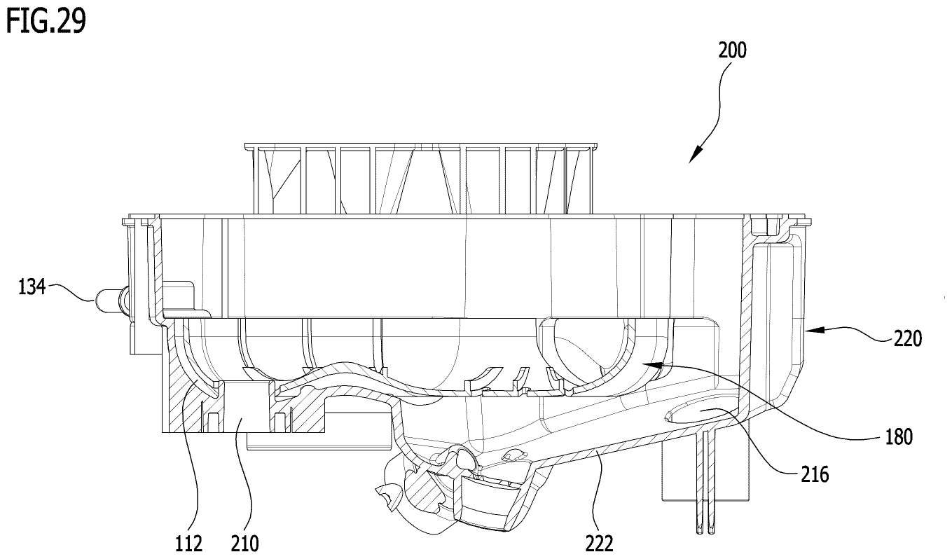

Since the channel base element 180 is almost completely covered by the surrounding body 220, it is not described in more detail in connection with FIGS. 20 to 24. The channel base element 180 received in the body is however clearly visible in FIGS. 27 and 28. There the fluid-guiding unit 200 of the first embodiment is shown without the channel cover element 160.

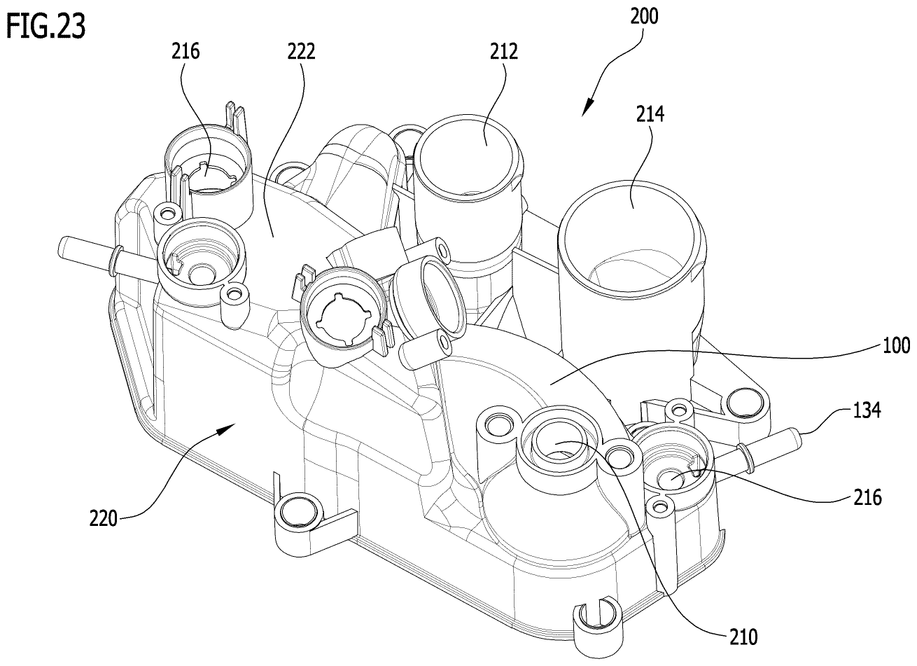

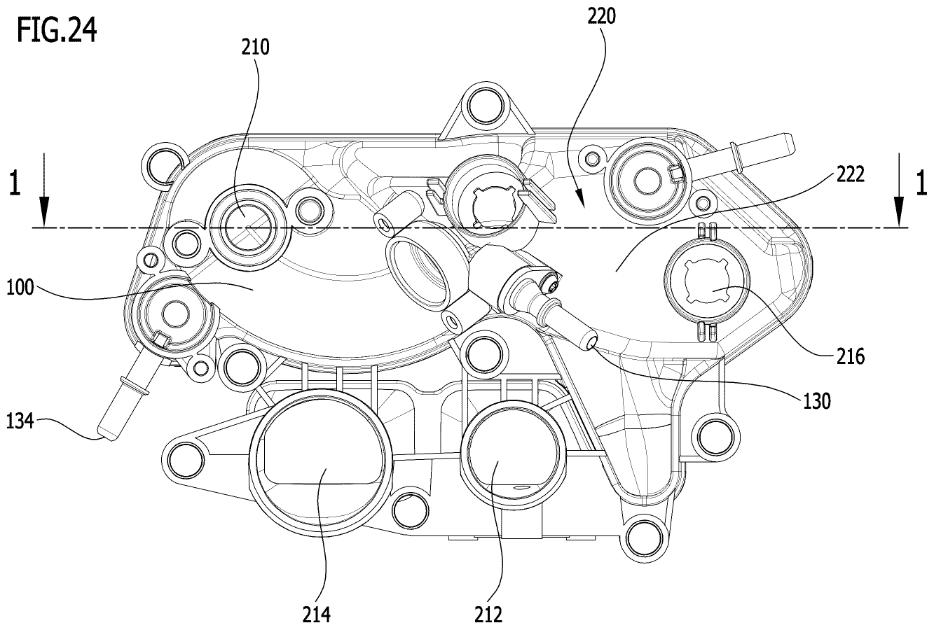

The region functioning as a liquid separator 100 is also delimited at the bottom, below the channel base element, by a region of the body 220, wherein this region has an opening for the fluid outlet 210 (see FIGS. 23 and 24). The fluid-guiding unit 200 also has several sensor-receiving regions 216. Sensors for measuring liquid states may be received for example in the sensor-receiving regions 216.

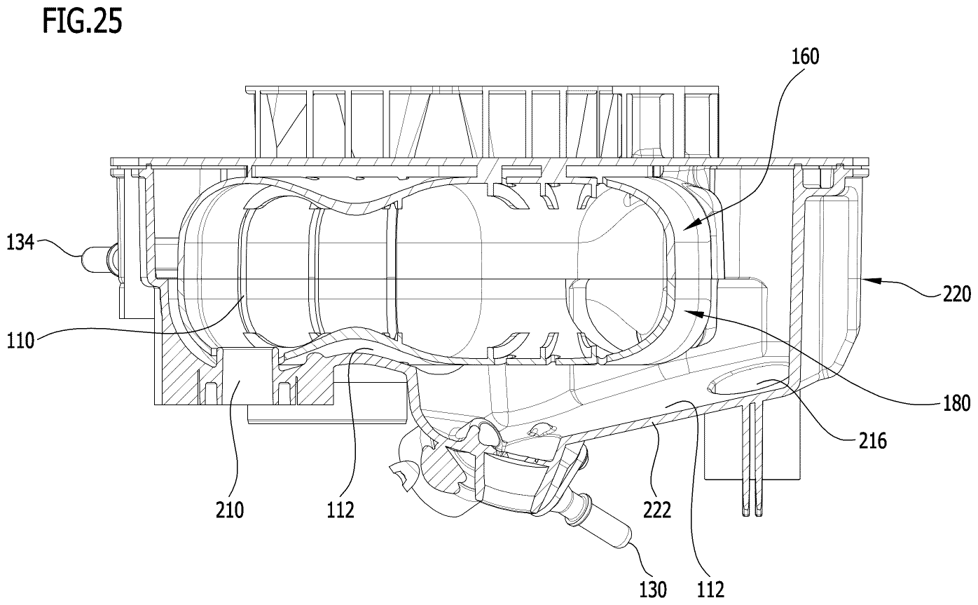

The sectional views of FIGS. 25, 26, 29 and 30 also clearly show the channel base element 180. The figures also show that a cavity is formed between the channel base element 180 and the body 220, and serves as a liquid-collecting region 112. This also extends up to the region near the fluid outlet 210.

Accordingly, all liquid which passes through one of the liquid passages 110 can collect close to the liquid outlet 130 and be discharged in targeted fashion through a drainage valve.

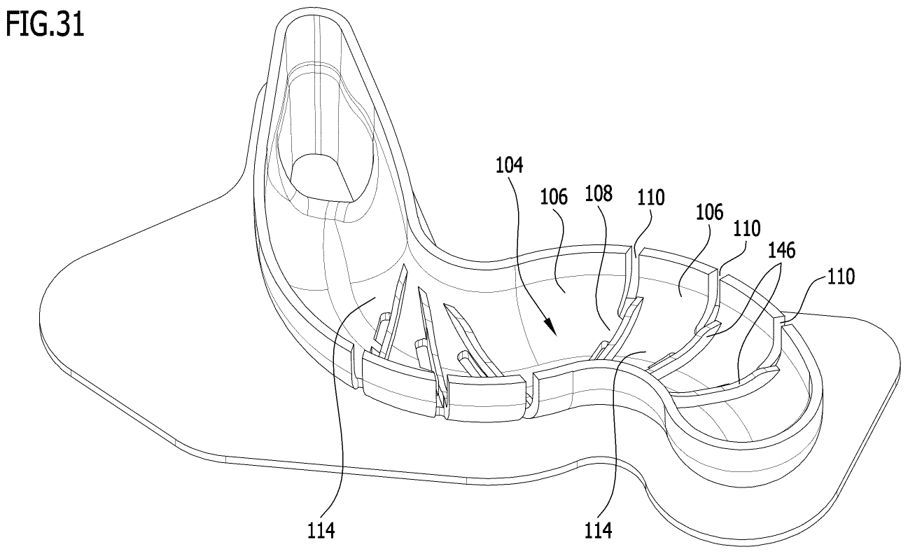

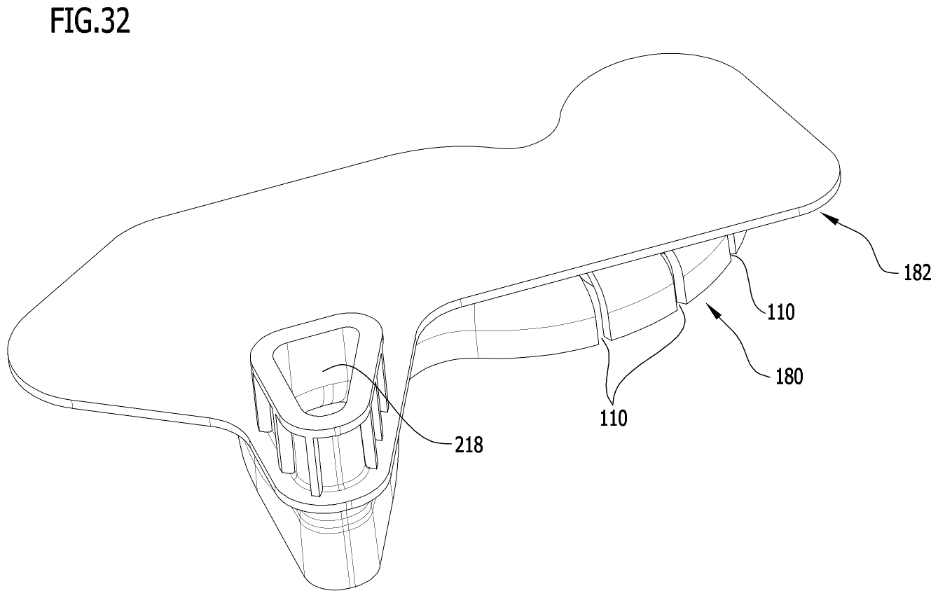

FIGS. 31 to 35 show various views of a channel base element 180 for a second embodiment of a liquid separator according to the invention, and for a second embodiment of a fluid-guiding unit 200 according to the invention.

By deviation from the first embodiment, a floor element 182 is arranged on the channel base element 180 and may form a floor of the liquid-collecting region 112.

Also, in the second embodiment, the fluid inlet 218 passes through the floor element 182.

The fluid-guiding unit 200 of the second embodiment, shown in various views in FIGS. 36 to 39, comprises a body 220. To produce the fluid-guiding unit 200, the channel base element 180 is received in the body 220.

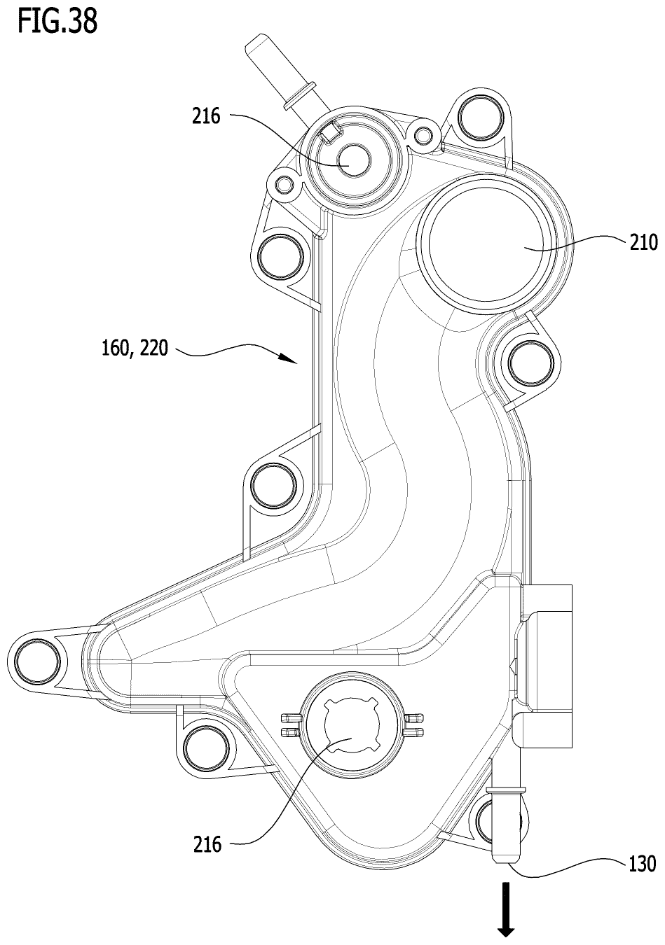

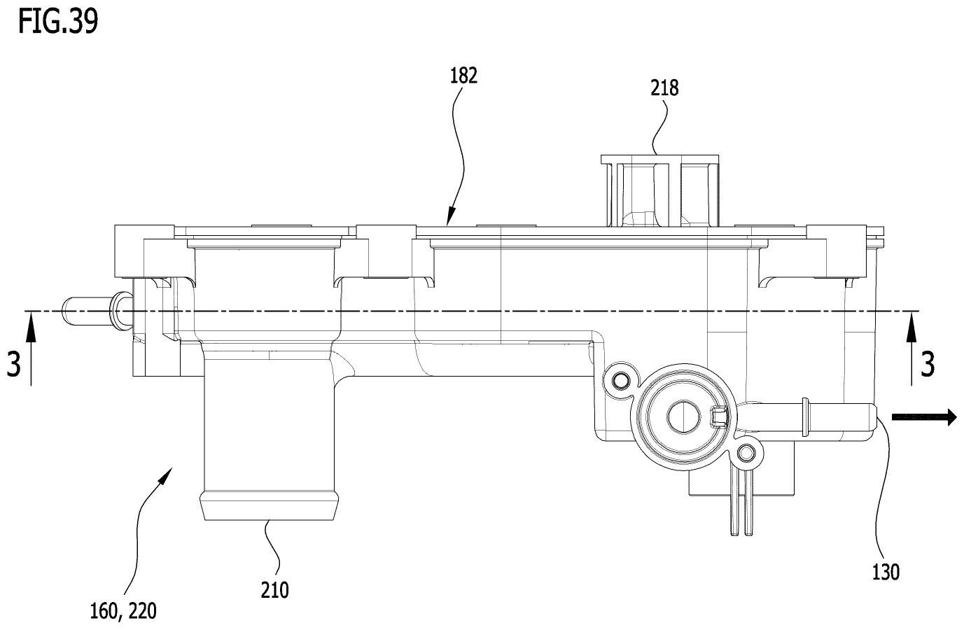

A liquid outlet 130 is formed in the liquid-collecting region such that it can be used for outlet of liquid from the liquid separator in a first orientation of the fluid-guiding unit 200 (see FIG. 38) and in a second orientation of the fluid-guiding unit 200 (see FIG. 39), as symbolized by the thick black arrows. Comparison of FIGS. 38 and 39 shows that the second orientation is tilted by 90° relative to the first orientation.

The fluid-guiding unit 200 or liquid separator formed therein can thus be fitted on fuel cell stacks with vertical and horizontal cell orientation.

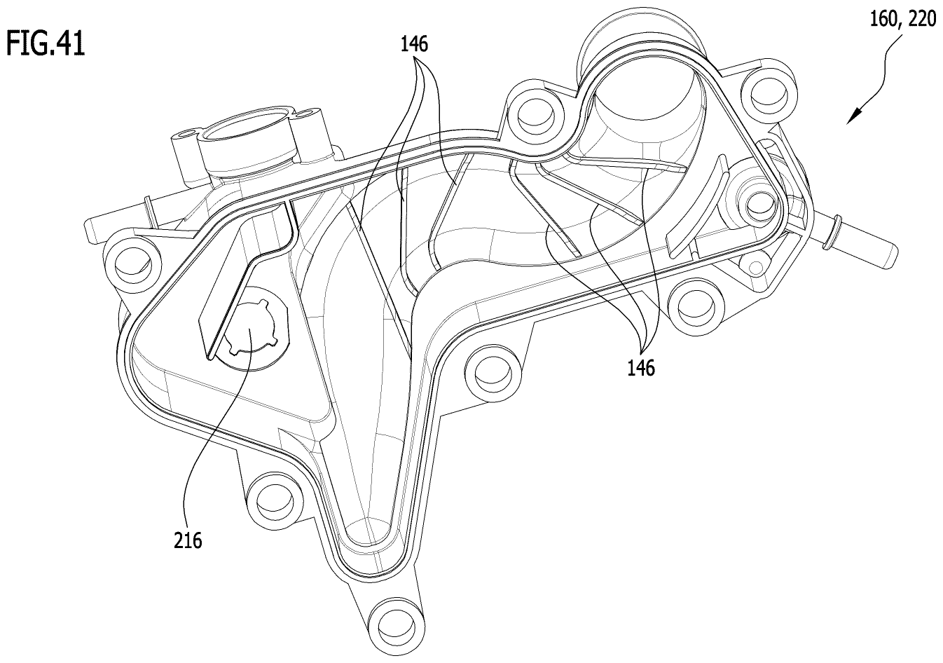

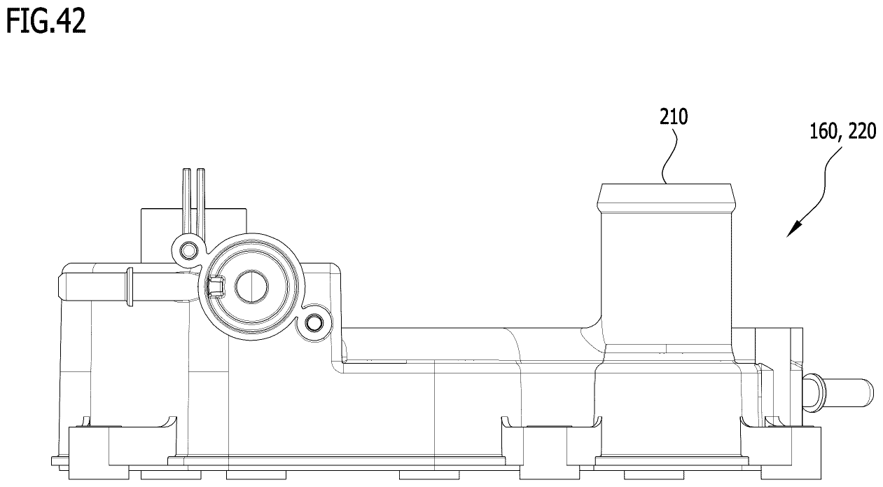

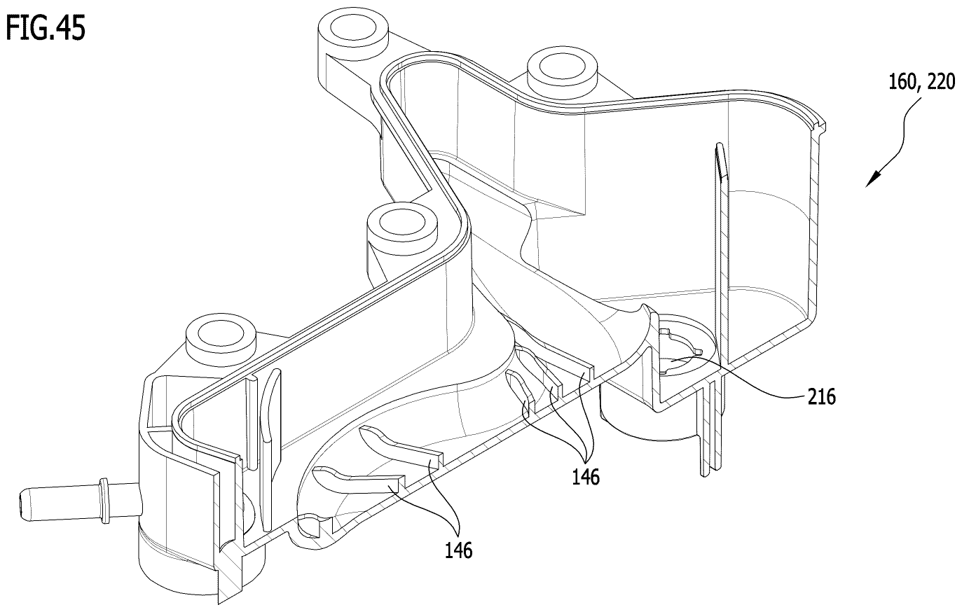

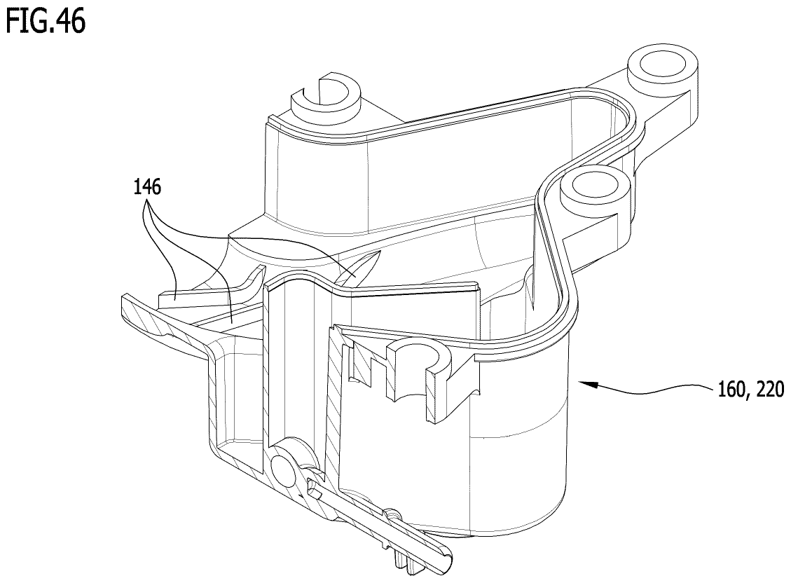

In the second embodiment, the body 220 also functions as a channel cover element 160. The body 220 is shown in FIGS. 41 to 44 without the channel base element 180. FIGS. 45 and 46 also show the body 220 in sectional views without channel base element 180.

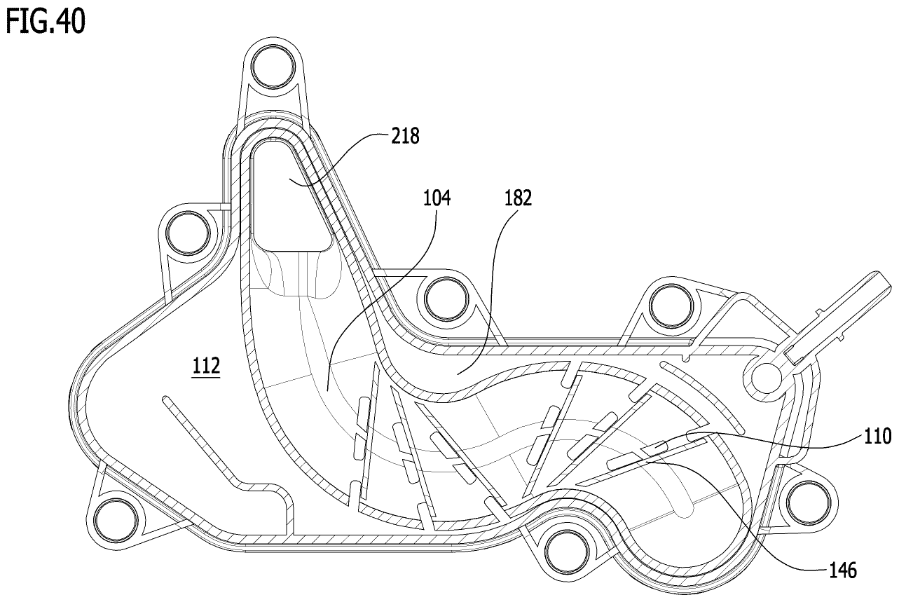

In particular FIGS. 40, 41 and 45 show that the body 220 and the upper half of the fluid-conducting channel 104 may be formed as one piece.

### LIST OF REFERENCE SIGNS

Liquid separator 100
Fluid-conducting channel 104
Catchment region 106
Outflow zone 108
Liquid passage 110
Liquid-collecting region 112
Curvature 114
Channel wall 116
Backflow barrier 118
Deflection region 120
Barrier panel element 122
Baffle panel element 124
Rib 126
Labyrinth path 128
Liquid outlet 130
Outlet region 132
Inlet 134
Backflow barrier insert 136
First portion 138
First channel wall portion 140
Second portion 142
Liquid barrier 144
Liquid-conducting element 146
Gas-conveying device 148
Runoff surface 150
Channel cover element 160
Channel base element 180
Floor element 182
Fluid-guiding unit 200
Fluid outlet 210
Coolant-guiding zone 212
Air-conducting zone 214
Sensor-receiving region 216
Fluid inlet 218
Body 220
Body floor element 222
Gas distribution layer 300

1. A liquid separator, in particular for a fuel cell device, wherein the liquid separator comprises the following:
a fluid-conducting channel;
a catchment region for capturing liquid from a fluid which can be conveyed in the fluid-conducting channel;
a liquid passage branching off the fluid-conducting channel; and
a liquid-collecting region into which the liquid passage opens.

2. The liquid separator as claimed in claim 1, wherein a transition from the catchment region to the liquid passage forms an outflow zone via which a liquid, which can be captured in the catchment region, can flow out to the liquid passage.

3. The liquid separator as claimed in claim 1, wherein a liquid-conducting element leads to the liquid passage.

4. The liquid separator as claimed in claim 1, wherein the fluid-conducting channel has at least one curvature, and at least part of the catchment region is formed at a channel wall of the fluid-conducting channel lying radially on the outside in the flow direction of the fluid.

5. The liquid separator as claimed in claim 1, wherein at least one, for example at least four, backflow barriers is arranged between the liquid-collecting region and the fluid-conducting channel.

6. The liquid separator as claimed in claim 1, wherein at least one backflow barrier defines a deflection region opening towards the liquid-collecting region.

7. The liquid separator as claimed in claim 1, wherein ribs define a labyrinth path which runs into the liquid-collecting region or inside the liquid-collecting region.

8. The liquid separator as claimed in claim 1, wherein a liquid outlet is formed in the liquid-collecting region and may assume an open or a closed state.

9. The liquid separator as claimed in claim 1, wherein a liquid outlet is formed in the liquid-collecting region, wherein the liquid outlet is formed in the liquid-collecting region such that it can be used for outlet of separated liquid in a first orientation of the liquid separator and in a second orientation of the liquid separator, wherein the second orientation is tilted preferably by 90° relative to the first orientation.

10. The liquid separator as claimed in claim 1, wherein an inlet is arranged above the liquid-collecting region.

11. The liquid separator as claimed in claim 1, wherein the fluid-conducting channel has at least one first portion with widened channel cross-section, and that at least a part of the catchment region is formed at a first channel wall portion lying in this first portion, wherein the first portion preferably transforms into a second portion of the fluid-conducting channel with smaller cross-section, and wherein preferably a liquid barrier is formed at the transition from the first portion to the second portion.

12. A method for separating liquid, for example a watery liquid, from a fluid, wherein:
the liquid is separated from the fluid in a fluid-conducting channel and the separated liquid is conveyed via a liquid passage branching from the fluid-conducting channel into a liquid-collecting region and collected therein.

13. The method for separating a watery liquid from a fluid as claimed in claim 12, wherein the fluid contains at least 10 vol. % of a gaseous fuel, e.g. H₂.

14. A fluid-guiding unit for a fuel cell device, comprising:
a liquid separator as claimed in claim 1,
a) wherein the fluid-conducting channel is received in a body such that a body floor element forms a floor of the liquid-collecting region, or
b) wherein on at least one channel base element, a floor element is arranged which forms a floor of the liquid-collecting region.

15. The fluid-guiding unit as claimed in claim 14, wherein a liquid outlet is formed in the liquid-collecting region, wherein the liquid outlet is formed in the liquid-collecting region such that it can be used for outlet of liquid from the fluid-guiding unit in a first orientation of the fluid-guiding unit and in a second orientation of the fluid-guiding unit, and wherein the second orientation is tilted preferably by 90° relative to the first orientation.

16. A component, for example an injection-molding, for production of a liquid separator as claimed in claim 1, wherein the component comprises the following:
a) a part of a fluid-conducting channel and
b) at least a part of a liquid passage branching from the part of the fluid-conducting channel,
wherein the component furthermore preferably comprises the following:
i) at least a part of a floor element which forms a floor of a liquid-collecting region, into which the liquid passage or the part of the liquid passage opens, and/or
ii) at least a part of a liquid-conducting element leading to the liquid passage or to the part of the liquid passage,
wherein it is preferably provided that the part of the fluid-conducting channel has at least one curvature.

17. A component set, e.g. an injection-molding set, for production of a liquid separator as claimed in claim 1.

18. A component, for example an injection-molding, for production of a fluid-guiding unit as claimed in claim 14, wherein the component comprises the following:
a) a part of a fluid-conducting channel and
b) at least a part of a liquid passage branching from the part of the fluid-conducting channel,
wherein the component furthermore preferably comprises the following:
i) at least a part of a floor element which forms a floor of a liquid-collecting region, into which the liquid passage or the part of the liquid passage opens, and/or
ii) at least a part of a liquid-conducting element leading to the liquid passage or to the part of the liquid passage,
wherein it is preferably provided that the part of the fluid-conducting channel has at least one curvature.

19. A component set, e.g. an injection-molding set, for production of a fluid-guiding unit as claimed in claim 14.
